(19) United States
(12) Patent Application Publication
(10) Pub. No.: US 2006/0135246 A1
(43) Pub. Date: Jun. 22, 2006

(54) Game machine and game system

(75) Inventor: Kazuo Okada, Koto-ku (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Aruze Corp., Koto-ku (JP)

(21) Appl. No.: 11/294,422

(22) Filed: Dec. 6, 2005

(30) Foreign Application Priority Data
Dec. 10, 2004 (JP) 2004-358722

(51) Int. Cl. A63F 13/00

(52) U.S. Cl. 463/20

(57) ABSTRACT

An apparatus is provided in which motivation is provided for a player to repeatedly play games and the expandability of overall game descriptions is enhanced to increase amusingness of games. It is a game machine which can play a variable display game in which based on whether or not to have read identification information stored in a game item, a game mode is determined as either a first game progress mode which can advance a game in a base game state that can play a base game and in a first special game state that can play a first special game, or a second game progress mode which can advance a game in the base game state and in a second special game state that can play a second special game using identification information of the game item.

### RELATED APPLICATIONS

This application claims the priority of Japanese Patent Application No. 2004-358722 filed on Dec. 10, 2004, which is incorporated by reference.

### BACKGROUND OF THE INVENTION

1. Field of the Invention

The present invention relates to a game machine and a game system using multiple motifs which are variably displayed.

2. Description of the Related Art

Traditionally, there is a game machine in which multiple motifs are variably displayed in multiple columns or variable display images in multiple motifs are displayed in multiple columns, whether or not to win a game and a mode are determined when win a game (winning mode) in accordance with the combinations of motifs in individual columns when variable display is stopped, and a game medium such as a medal and a token (hereinafter, it is called “a coin”), which are used in games, is paid out depending on a winning mode. This type of game machine sometimes has a special game state that can play a bonus game under conditions such as certain motifs being stopped and displayed, in addition to a base game state that can play a base game. Furthermore, the descriptions of a bonus game played in the special game state are sometimes varied at random or varied depending on selection done by a player.

For example, Japanese Unexamined Patent Publication No. 2002-537874 discloses a game machine having multiple bonus games in which a bonus game to be played is decided at random among them by lottery, or whether to play a bonus game or to offer a bonus prize is decided depending on selection by a player.

Furthermore, Japanese Unexamined Patent Publication No. 2003-180908 discloses a game machine in which free games as a bonus game can be done for a predetermined number of times and the number of times to play a free game is added when a predetermined number of certain motifs is stopped during a single free game.

### SUMMARY OF THE INVENTION

The game machines disclosed in Japanese Unexamined Patent Publication No. 2002-537874 and Japanese Unexamined Patent Publication No. 2003-180908 can both move from the base game state to the special game state by establishing a predetermined condition, and can play a bonus game that can vary the game descriptions when moved to the special game state. However, even though the game machines disclosed in Japanese Unexamined Patent Publication No. 2002-537874 and Japanese Unexamined Patent Publication No. 2003-180908 can play a bonus game that can vary the game descriptions, they can merely play games prepared beforehand. Therefore, they have a problem that a player repeatedly plays games, the player is then bored soon or later, and it is hard to provide motivation for the player to repeatedly play games. Moreover, they also have a problem that the determination itself whether or not to move to a bonus game is done only in a predetermined manner and the expandability of the overall game descriptions is poor.

Then, an object of the invention is to provide a game machine and a game system, which provides motivation for a player to repeatedly play games and the expandability of the overall game descriptions is enhanced to increase amusingness of games.

In order to solve the problem, the invention is a game machine capable of playing a variable display game using multiple motifs that are variably displayed, the game machine including:

a reading module which reads identification information from a game item that stores identification information which distinguishes oneself from another;

a read determining module which determines whether or not to have read the identification information by the reading module;

a mode determining module which determines which game progress mode it is, a first game progress mode or a second game progress mode based on whether or not to have read the identification information by the read determining module, wherein the first game progress mode can advance a game in a base game state that can play the variable display game and in a first special game state that can play a first special game different from the variable display game, and the second game progress mode can advance a game in the base game state and in a second special game state that can play a second special game using the identification information read by the reading module; and

a game progress control module which advances a game in the first or second game progress mode determined by the mode determining module.

In the game machine, based on whether or not to have read identification information by the reading module, the game progress mode is determined as either the first game progress mode or the second game progress mode. In the first game progress mode, the first special game is played in the first special game state, whereas in the second game progress mode, the second special game using identification information stored in the game item in the second special game state.

According to the invention, motivation can be provided for a player to repeatedly play games. In addition, the expandability of the overall game descriptions can be enhanced to increase amusingness of games.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DISCLOSURE OF THE INVENTION

The invention is a game machine capable of playing a variable display game using multiple motifs that are variably displayed, the game machine including:

a reading module which reads identification information from a game item that stores identification information which distinguishes oneself from another;

a read determining module which determines whether or not to have read the identification information by the reading module;

a mode determining module which determines which game progress mode it is, a first game progress mode or a second game progress mode based on whether or not to have read the identification information by the read determining module, wherein the first game progress mode can advance a game in a base game state that can play the variable display game and in a first special game state that can play a first special game different from the variable display game, and the second game progress mode can advance a game in the base game state and in a second special game state that can play a second special game using the identification information read by the reading module; and

a game progress control module which advances a game in the first or second game progress mode determined by the mode determining module.

In the game machine, based on whether or not to have read identification information by the reading module, the game progress mode is determined as either the first game progress mode or the second game progress mode. In the first game progress mode, the first special game is played in the first special game state, whereas in the second game progress mode, the second special game using identification information stored in the game item in the second special game state.

Furthermore, the invention includes a display which displays the motif as a variable display image. More specifically, it is a game machine capable of playing a variable display game using variable display images in multiple motifs, the game machine including:

a reading module which reads identification information from a game item that stores identification information which distinguishes oneself from another;

a read determining module which determines whether or not to have read the identification information by the reading module;

a mode determining module which determines which game progress mode it is, a first game progress mode or a second game progress mode based on whether or not to have read the identification information by the read determining module, wherein the first game progress mode can advance a game in a base game state that can play the variable display game and in a first special game state that can play a first special game different from the variable display game, and the second game progress mode can advance a game in the base game state and in a second special game state that can play a second special game using the identification information read by the reading module; and

a game progress control module which advances a game in the first or second game progress mode determined by the mode determining module.

In the game machine, based on whether or not to have read identification information by the reading module, the game progress mode is determined as either the first game progress mode or the second game progress mode. In the first game progress mode, the first special game is played in the first special game state, whereas in the second game progress mode, the second special game using identification information stored in the game item in the second special game state.

Moreover, the second special game may be conducted using a usage of the game item corresponding to the identification information.

In the game machine like this, the second special game using the usage of the game item corresponding to identification information stored in the game item is played in the second game progress mode.

Besides, the invention is a game system having:

a game machine which can play variable display game using multiple motifs that are variably displayed; and

a game server which is connected to the game machine, wherein:

the game machine includes:

a reading module which reads identification information from a game item that stores identification information which distinguishes oneself from another;

a read determining module which determines whether or not to have read the identification information by the reading module;

a communication processing module which sends the identification information read by the reading module to the game server and receives a usage of the game item corresponding to the sent identification information from the game server;

a mode determining module which determines which game progress mode it is, a first game progress mode or a second game progress mode based on whether or not to have read the identification information by the read determining module, wherein the first game progress mode can advance a game in a base game state that can play the variable display game and in a first special game state that can play a first special game different from the variable display game, and the second game progress mode can advance a game in a second special game state that can play a second special game using a usage received by the communication processing module and

a game progress control module which advances a game in the first or second game progress mode determined by the mode determining module, and

the game server includes:

a communication processing module which receives identification information sent from the game machine and sends usage information indicating a usage of the game item corresponding to the received identification information to the game machine.

In the game system, identification information stored in the game item is read by the reading module by the game machine and sent to the game server. Usage information corresponding to the identification information is sent to the game machine by the game server, and the second special game using the usage information is played in the second game progress mode.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principals of the invention.

The teachings of the invention can be readily understood by considering the following detailed description in conjunction with the accompanying drawings, in which:

FIG. 1 is a perspective view illustrating the overall configuration of a slot machine of a first embodiment of a game machine according to the invention;

FIG. 2 is a front view illustrating a main display of the slot machine shown in FIG. 1;

FIG. 3 is a perspective view illustrating the configuration of reels;

FIG. 4 is a perspective view illustrating one of the reels shown in FIG. 3;

FIG. 5 is a perspective view illustrating the schematic configuration of a main liquid crystal display device seen from the back side of a cabinet;

FIG. 6 is an exploded perspective view illustrating a part of the main liquid crystal display device;

FIG. 7 is a block diagram mainly illustrating the internal configuration of the slot machine according to the first embodiment;

FIG. 8 is a block diagram illustrating an exemplary internal configuration of an image control circuit;

FIG. 9 is a partially broken front view illustrating a figure;

FIG. 10 is a flow chart illustrating the operation procedures from the beginning to the end of a slot game;

FIG. 11 is a flow chart illustrating the operation procedures of a figure information read process;

FIG. 12 is a flow chart illustrating the operation procedures of a no-figure game process;

FIG. 13 is a flow chart illustrating the operation procedures of a figure employed game process;

FIG. 14 is a flow chart illustrating the operation procedures of a figure employed bonus game process according to the first example;

FIG. 15 is a flow chart illustrating the operation procedures of a figure employed bonus game process according to a second example;

FIG. 16 is a diagram illustrating an exemplary figure information record stored in an IC chip;

FIG. 17 is a diagram illustrating an exemplary special lottery chance decision table;

FIG. 18 is a perspective view illustrating the overall configuration of a slot machine of a second embodiment of the game machine according to the invention;

FIG. 19 is a block diagram mainly illustrating the internal configuration of the slot machine according to a second embodiment;

FIG. 20 is a flow chart illustrating the operation procedures of a figure employed bonus game process in the slot machine according to the second embodiment;

FIG. 21 is a diagram illustrating a display image of a labyrinth combat image game;

FIG. 22 is a diagram illustrating a display image of the labyrinth combat image game in combat;

FIG. 23 is a block diagram illustrating the schematic configuration of a game system; and

FIG. 24 is a flow chart illustrating the operation procedures from the beginning to the end of a slot game in the game system.

### DESCRIPTION OF THE PREFERRED EMBODIMENT

Hereinafter, embodiments according to the invention will be described. In addition, the same components are assigned the same numerals and signs, omitting the overlapped description.

A slot machine 1A of a first embodiment according to the invention can play games in a first game progress mode and a second game progress mode. In which game progress mode a game is played is decided depending on whether or not to have read a figure ID, described later. In the first game progress mode, a game can move in a base game state that can play a normal variable display game that is started from the beginning of the game with no conditions (hereinafter, it is called a base game), and in a first special game state that can play a first special game that is started under a fixed condition subsequent to the base game. Furthermore, in the second game progress mode, a game can move in the base game state described above and a second special game state that can play a second special game. Moreover, the first special game according to the embodiment is a free game for a predetermined number of times (for example, three times) (a game in which reels are automatically rotated and stopped after a fixed time elapsed, and coins are paid out in accordance with a stopped motif pattern, with no need to insert a new coin), and the second special game is a special lottery game, described later. In addition, the slot machine 1A is a coin insertion type game machine that requires inserting a coin when a game is started. Hereinafter, the configuration of the slot machine IA will be described.

(Overall Configuration of the Slot Machine)

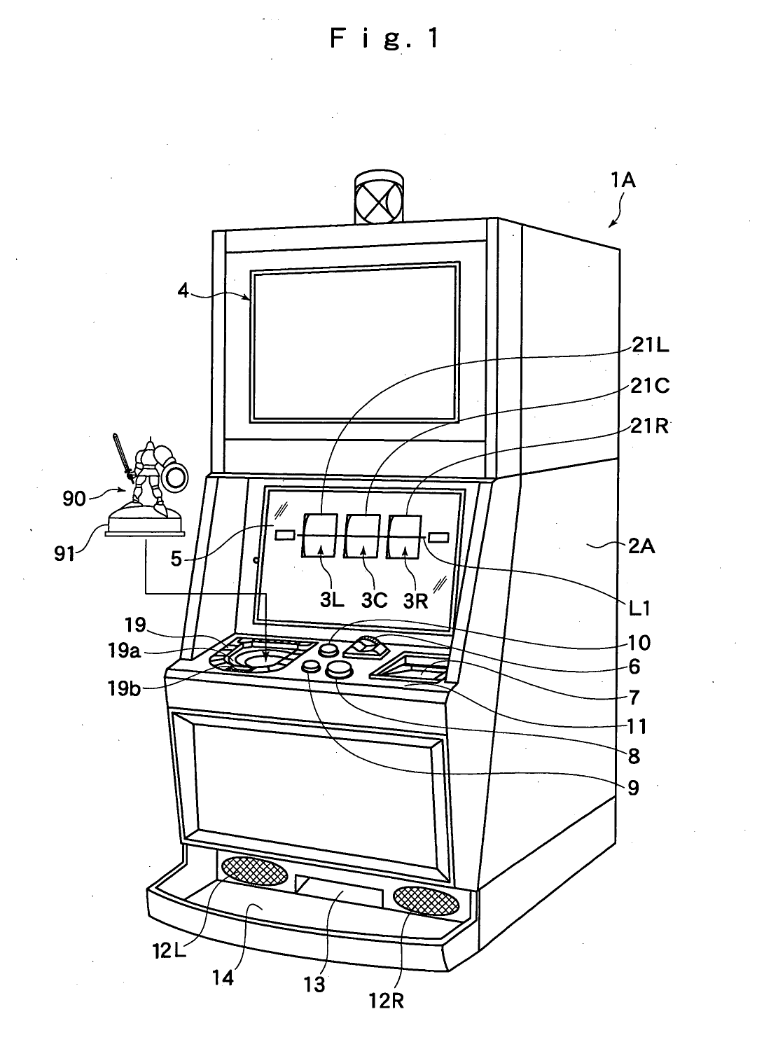

FIG. 1 is a perspective view illustrating the overall configuration of the slot machine 1A. The slot machine 1A has a variable display module which variably displays multiple motifs, and is configured to play a variable display game (slot game) by the variable display module using variable display in multiple motifs. This slot game is the base game described above.

Sequentially from the upper side on the front side of a cabinet 2A, the slot machine 1A has a sub-display 4, and a main display 5. The main display 5 is placed nearly at the center of the cabinet 2A vertically, and three mechanical reels 3L, 3C, and 3R are rotatably placed in a row inside the cabinet 2A as corresponding to the main display 5.

Each of the reels 3L, 3C, and 3R can be visibly recognized from outside through motif display areas 21L, 21C, and 21R of the main display 5, described later. Although each of the reels 3L, 3C, and 3R will be described in detail later, a motif string is depicted in multiple types of motifs on the outer surface of each reel (not shown). The reels configure the variable display module which is rotatable so as to variably display each motif, and each rotates at a constant speed (for example, 80 rpm).

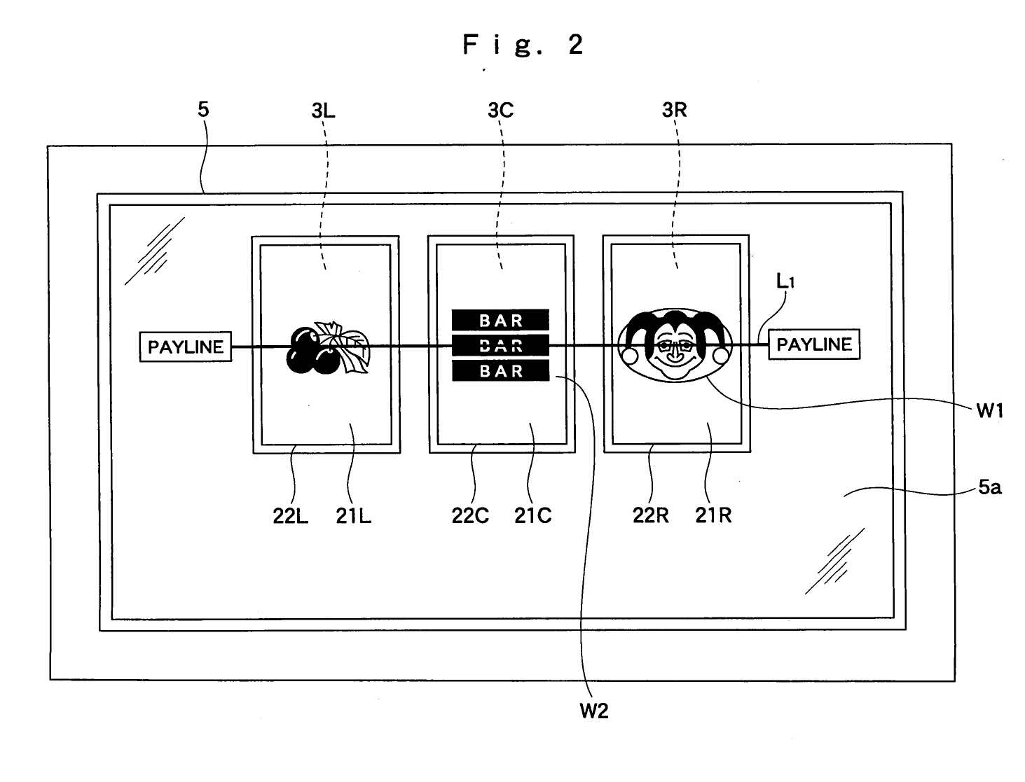

Corresponding to each of the reels 3L, 3C, and 3R, a single pay line L1 that extends horizontally is disposed across the motif display areas 21L, 21C, and 21R, as shown in FIG. 2. In addition, not shown in the drawing, in addition to the pay line L1, another pay line may be disposed above and below, and two pay lines may be further disposed across diagonally. When multiple pay lines are disposed, the number of the lines may be varied in accordance with the number of coins to be inserted. In this case, each of the pay lines become valid in accordance with the number of coins to be inserted and the manipulation of BET switches 9 and 10. The valid pay line is also called a valid line or a pay line. For example, when a player inserts a coin into a coin insertion slot 6, described later, only the pay line L1 at the center becomes a valid line. When the player inserts two coins, the above and below pay lines are added in addition to the pay line L1. When the player inserts three coins, all the pay lines become the valid lines. In addition, in FIG. 2, for convenience to see, it is shown that motifs are stopped only on the pay line L1, but typically, three motifs are displayed vertically in each of the motif display areas 21L, 21C, and 21R.

Furthermore, in the slot machine 1A, an operation panel 11 is disposed nearly horizontally below the main display 5. On the operation panel 11, a figure setting unit 19, the coin insertion slot 6, a bill insertion slot 7, a spin switch 8, a single BET switch 9, and a maximum BET switch 10 are disposed.

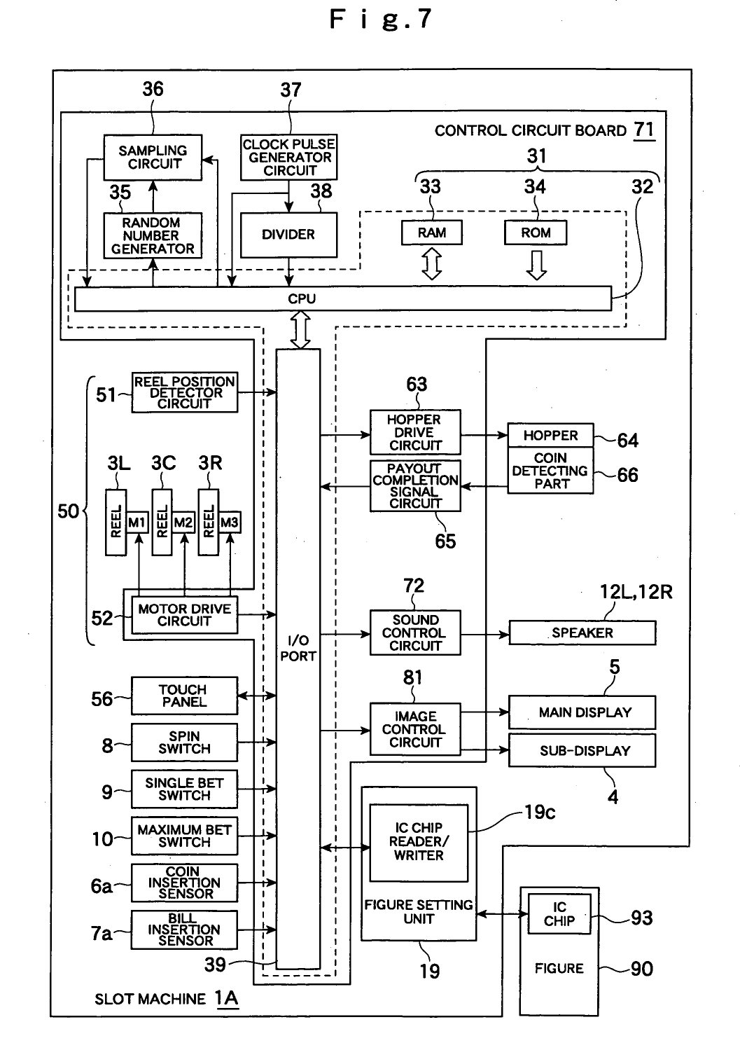

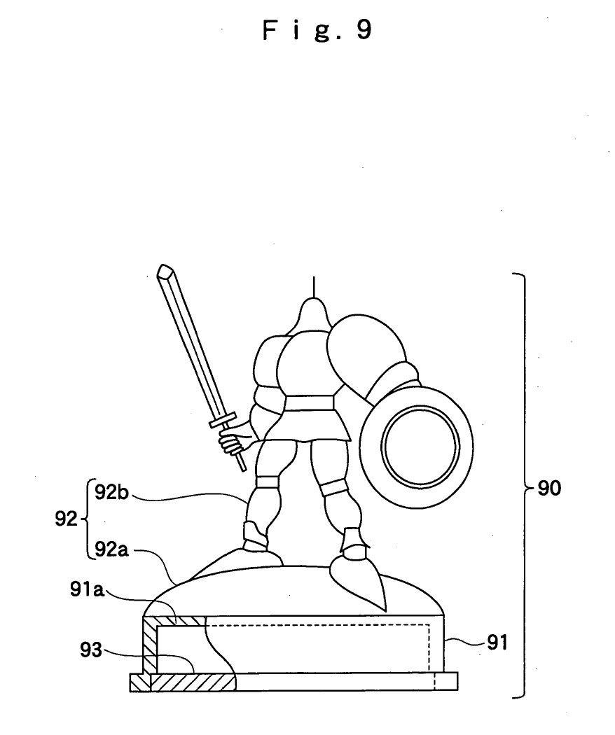

The figure setting unit 19 has a base mount part 19a fixed to the surface of the operation panel 11, and a reading part 19b. The base mount part 19a has a thick disk-shaped recess inside thereof, the recess corresponds to the shape of a base part 91 of a FIG. 90 (see FIG. 9), and the base part 91 can be fit into the recess. The reading part 19b is placed in the recess of the base mount part 19a, and has an IC chip reader/writer 19c (see FIG. 7). The IC chip reader/writer 19c is connected to a CPU 32 through an I/O port 39, which reads recorded information (the figure ID, etc.) from an IC chip 93 built in the base part 91 of the set FIG. 90, enters it to the CPU 32, and writes a predetermined item of information to the IC chip 93 in accordance with an instruction from the CPU 32. The IC chip reader/writer 19c corresponds to a reading module in the invention. In addition, not shown in the drawing, the figure setting unit 19 has an LED to irradiate light onto the figure by the LED during the read operation of the figure 90, described later.

The coin insertion slot 6 is placed for a player to insert a coin for betting a game, and has a coin insertion sensor 6a (See FIG. 7) which outputs a signal indicating coin insertion. Furthermore, a bill insertion slot 7 is placed for a player to insert a bill, and has a bill insertion sensor 7a (See FIG. 7) which outputs a signal indicating bill insertion. The spin switch 8 is placed to start variable display of motifs by rotating each of the reels 3L, 3C, and 3R in the motif display areas 21L, 21C, and 21R, that is, a player manipulates it to start a game. The single BET switch 9 is placed to set a single coin for a bet by a single manipulation. The maximum BET switch 10 is placed to set the maximum number of coins for a bet on a single game by a single manipulation.

Moreover, in the slot machine 1A, a coin payout port 13 and a coin tray 14 which holds paid out coins are placed on the bottom of the cabinet 2A. Besides, speakers 12L and 12R are placed on the right and left sides of the coin payout port 13 as sandwiched.

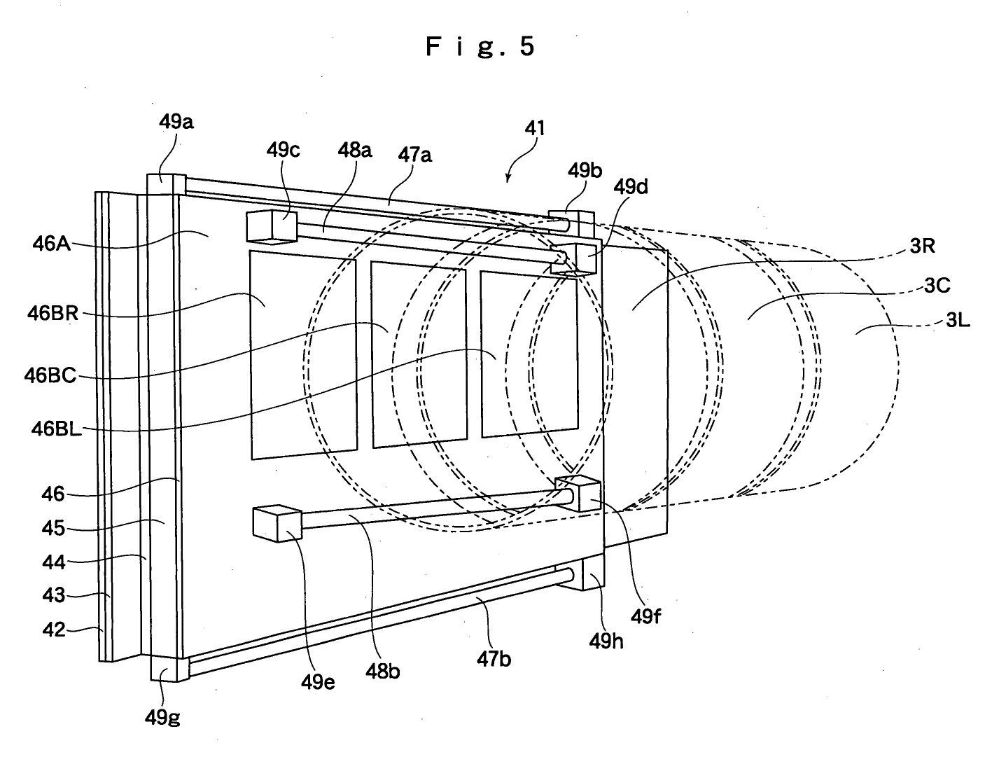

As shown in FIG. 2, the main display 5 has the motif display areas 21L, 21C, and 21R, window frame display areas 22L, 22C, and 22R, and an effect display area 5a. The display descriptions of the main display 5 are varied in accordance with the variable display mode and the stop mode of the reels 3L, 3C, and 3R, and the operation descriptions of a main liquid crystal display device 41 (see FIG. 5), described later. In addition, although the main display 5 has a BET number display part, a payout display part, a credit display part, etc. other than those components, they are omitted in FIG. 2.

The motif display areas 21L, 21C, and 21R are placed as corresponding to each of the reels 3L, 3C, and 3R, and are display areas where motifs depicted on each of the reels 3L, 3C, and 3R can be visibly recognized. In addition, when each of the corresponding reels 3L, 3C, and 3R is being rotated, and when their rotation is stopped, transmissive display is done in the motif display areas 21L, 21C, and 21R which allows a player to visibly recognize motifs depicted on each of the reels 3L, 3C, and 3R in scrolling. Effect display is not done by static images or moving images such as motifs, letters, graphics, symbols, and characters.

The window frame display areas 22L, 22C, and 22R are placed so as to surround the corresponding motif display areas 21L, 21C, and 21R, and function as a display window for a motif depicted on each of the reels 3L, 3C, and 3R.

Furthermore, in the effect display area 5a, images for a special lottery game, described later, are displayed. In addition to this, in the effect display area 5a, effects for increasing amusingness of games and information for playing a game advantageously by a player are displayed.

The display descriptions of the sub-display 4 are varied in accordance with the operation descriptions of a sub-liquid crystal display device, described later.

(Configuration of the Reel)

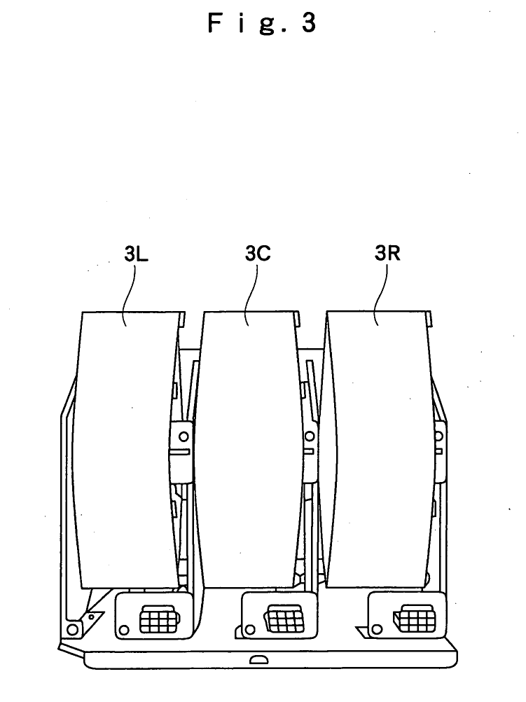

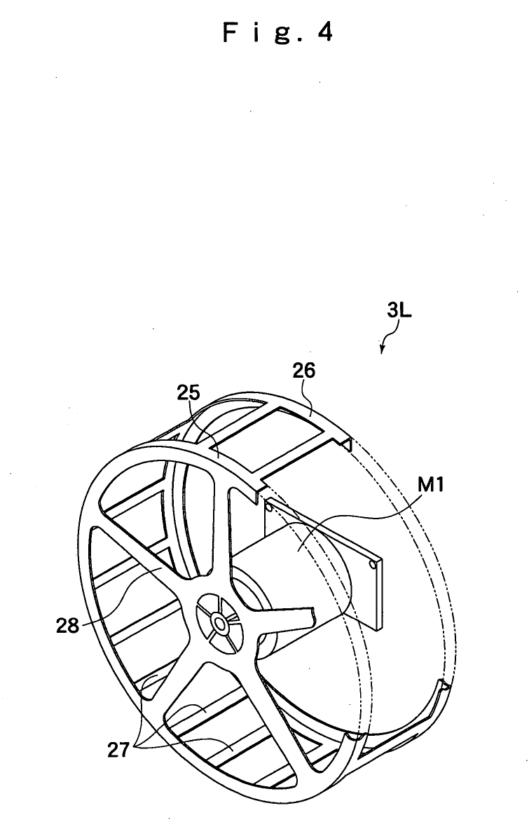

As shown in FIG. 3, each of the reels 3L, 3C, and 3R are placed in a row, each reel is rotatable, having the same configuration. As shown in FIG. 4, the reel 3L has a cylindrical frame in which two ring-shaped frames 25 and 26 in the same shape are spaced at a predetermined interval and the ring-shaped frames 25 and 26 are coupled by multiple coupling members 27. Furthermore, as shown in FIG. 4, the reel 3L has a transport member 28 which transmits drive force of a stepping motor M1 (See FIG. 7) placed at the center of the cylindrical frame to the ring-shaped frames 25 and 26, and a reel sheet, not shown, is disposed on the side surface so as to cover the coupling member 27. Multiple motifs are depicted on the reel sheet. In addition, not shown in the drawing, for each of the reels 3L, 3C, and 3R, a circuit board for housing an LED and an LED lamp may be placed on the back side of the motifs (nine motifs in total) in three columns wide shown in the motif display areas 21L, 21C, and 21R when rotation is stopped. If so, the LED lamp can irradiate white light from the back side of the reel sheet to illuminate the main display 5, and the irradiation manner can be devised to do effects for the game descriptions.

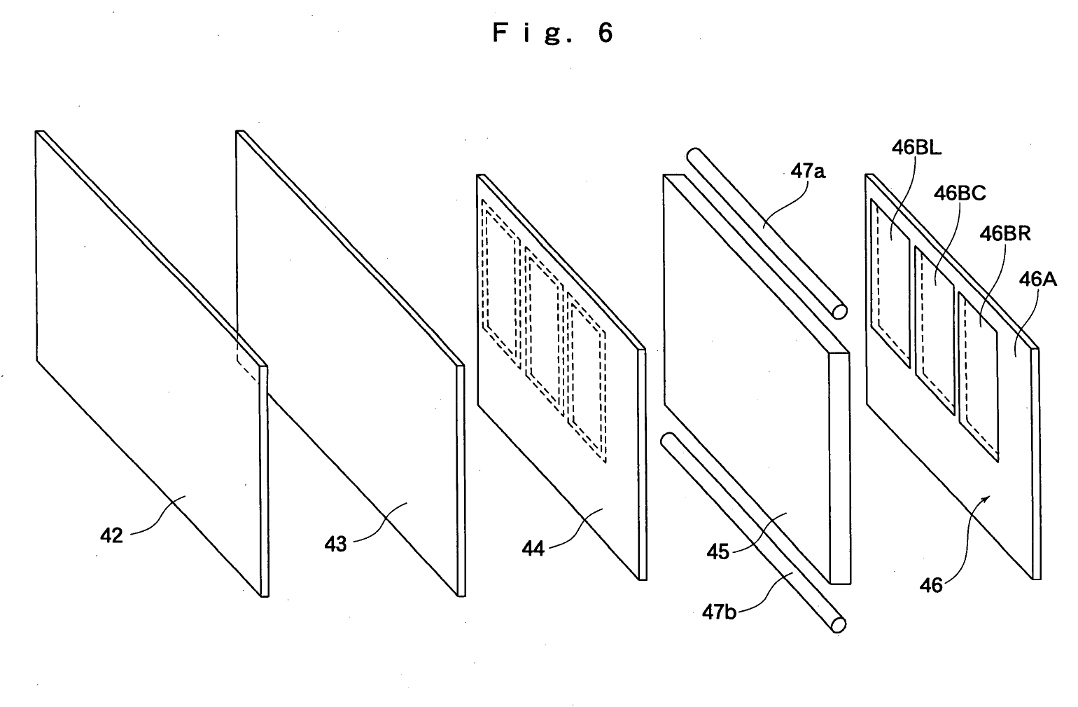

Next, the main liquid crystal display device 41 configuring the main display 5 will be described with reference to FIGS. 5 and 6. FIG. 5 is a perspective view illustrating the schematic configuration of the main liquid crystal display device 41 seen from the back side of the cabinet 2A. FIG. 6 is a partially exploded perspective view illustrating the main liquid crystal display device 41.

The main liquid crystal display device 41 is placed across on the front side of each of the reels 3L, 3C, and 3R, as with a predetermined interval is spaced at each of the reels 3L, 3C, and 3R. The main liquid crystal display device 41 has a protective glass 42, a display plate 43, a liquid crystal panel 44, a light guide plate 45, a reflective film 46, fluorescent lamps 47a, 47b, 48a, and 48b which are white light sources, lamp holders 49a to 49h, and a flexible substrate (not shown) which is connected to terminal parts of the liquid crystal panel 44 and is formed of a table carrier package (TCP) mounted with a drive IC for the liquid crystal panel 44.

The protective glass 42 and the display plate 43 have light transparency. The protective glass 42 is placed mainly for protection of the liquid crystal panel 44. The display plate 43 has a predetermined image depicted thereon, not shown. The liquid crystal panel 44 is configured to have a transparent substrate such as a glass plate formed with thin film transistors and a transparent substrate facing thereto with liquid crystal encapsulated therebetween for forming the motif display areas 21L, 21C, and 21R. The liquid crystal panel 44 is configured of normally white in which it is turned to white display (light is transmitted to the display screen side, and the light can be visibly recognized from outside) when voltage is not applied to liquid crystals (not driven), and the reels 3L, 3C, and 3R can be visibly recognized from the front side. The liquid crystal panel 44 configured of normally white is placed to allow visible recognition of motifs depicted on each of the reels 3L, 3C, and 3R through the motif display areas 21L, 21C, and 21R even though the encapsulated liquid crystal cannot be driven, and variable display and stop display of each of the reels 3L, 3C, and 3R can be visibly recognized to play a game.

The light guide plate 45 has transparency, which is placed on the back side of the liquid crystal panel 44 for guiding light from the fluorescent lamps 47a and 47b to the liquid crystal panel 44.

The reflective film 46 is placed which reflects light guided into the light guide plate 45 on the surface side of the light guide plate 45 and is formed of a silver film deposited on a white polyester film or an aluminium thin film. The reflective film 46 has a reflective area 46A and non-reflective areas 46BL, 46BC, and 46BR. The non-reflective areas 46BL, 46BC, and 46BR are formed of a transparent material, and are formed as a light transmission part which transmits incident light with no reflection. Furthermore, the non-reflective areas 46BL, 46BC, and 46BR are formed as corresponding to the motif display areas 21L, 21C, and 21R, and placed on the front of three motifs vertically arranged on each of the reels 3L, 3C, and 3R when they are stopped. The reflective area 46A reflects incident light, and operates as an illumination module for areas mainly corresponding to the window frame display areas 22L, 22C, and 22R and the effect display area 5a in the area of the liquid crystal panel 44.

The fluorescent lamps 47a and 47b are placed along the upper end part and the lower end part of the light guide plate 45, and the both ends are supported by each of lamp holders 49a, 49b, 49g, and 49h. The fluorescent lamps 47a and 47b generate light to be guided into the light guide plate 45, and operates as an illumination module for areas mainly corresponding to the window frame display areas 22L, 22C, and 22R and the effect display area 5a in the area of the liquid crystal panel 44.

The fluorescent lamps 48a and 48b are placed toward each of the reels 3L, 3C, and 3R at the upper and the lower positions on the back side of the reflective film 46. More specifically, light emitted from the fluorescent lamps 48a and 48b is reflected on the surface of each of the reels 3L, 3C, and 3R, enters the non-reflective areas 46BL, 46BC, and 46BR, and illuminates the liquid crystal panel 44. Thus, the fluorescent lamps 48a and 48b operate as an illumination module for motifs arranged on each of the reels 3L, 3C, and 3R, and an illumination module for areas corresponding to the motif display areas 21L, 21C, and 21R in the reflective film 46. On the other hand, the sub-liquid crystal display device is different from the main liquid crystal display device 41 in that a touch panel 56, described later, is not placed on the front side, and that the reels 3L, 3C, and 3R are not placed on the back side, although having the same configuration on the other components.

(Internal Configuration of the Slot Machine)

FIG. 7 is a block diagram mainly illustrating the internal configuration of the slot machine 1A. The slot machine 1A has multiple components as a control circuit board 71 including a microcomputer 31 is centered. The control circuit board 71 has a microcomputer 31, a random number generator 35, a sampling circuit 36, a clock pulse generator circuit 37, a divider 38, a hopper drive circuit 63, a payout completion signal circuit 65, a sound control circuit 72, and an image control circuit 81.

The microcomputer 31 has a CPU (Central Processing Unit) 32, RAM (Random Access Memory) 33, and ROM (Read Only Memory) 34. The CPU 32 operates as various modules featured in the invention in accordance with a program stored in the ROM 34, while it conducts input and output of signals with the other components through the I/O port 39 for operation control throughout the slot machine 1A. The RAM 33 stores data and a program used for the CPU 32 operating. For example, random number values sampled by the sampling circuit 36, described later, are temporarily stored therein after a game is started, and the code numbers and motif numbers of the reels 3L, 3C, and 3R are stored therein. Furthermore, the RAM 33 stores the figure ID read in a figure information read process, described later, is temporarily stored therein. The ROM 34 stores programs run by the CPU 32 and permanent data therein. For example, a special lottery chance decision table, described later, is stored therein.

The random number generator 35 operates in accordance with the instruction by the CPU 32, and generates random numbers within a fixed range. The sampling circuit 36 extracts a given random number among the random numbers generated by the random number generator 35 in accordance with the instruction by the CPU 32, and enters the extracted random number to the CPU 32. The clock pulse generator circuit 37 generates a reference clock to operate the CPU 32, and the divider 38 enters to the CPU 32 a signal that the reference clock is divided by a fixed period.

Moreover, the control circuit board 71 is connected to a reel drive unit 50. The reel drive unit 50 has a reel position detector circuit 51 which detects the position of each of the reels 3L, 3C, and 3R, and a motor drive circuit 52 which enters drive signals to motors M1, M2, and M3 to rotate each of the reels 3L, 3C, and 3R. The motor drive circuit 52 enters the drive signal to operate the motors M1, M2, and M3, and each of them rotates the reels 3L, 3C, and 3R. In addition to this, the control circuit board 71 is connected to the spin switch 8, the single BET switch 9, the maximum BET switch 10, the coin insertion sensor 6a, and the bill insertion sensor 7a, and each component enters signals thereto.

The hopper drive circuit 63 drives a hopper 64 in accordance with control by the CPU 32, and the hopper 64 operates to pay out coins to from the payout port 13. The payout completion signal circuit 65 enters data about the number of coins from a coin detecting part 66 connected thereto, and enters a signal to the CPU 32, the signal notifying completion of coin payout when the number of coins reaches a set number. The coin detecting part 66 counts the number of coins paid out from the hopper 64, and enters data about the counted number to the payout completion signal circuit 65.

Moreover, the sound control circuit 72 controls voice signals that output sounds from the speakers 12L and 12R in accordance with the instruction from the CPU 32, and causes the speakers 12L and 12R to output sounds. Thus, sounds to augment a game are outputted from the speakers 12L and 12R at a proper time, for example, after a game is started.

Furthermore, the CPU 32 is connected to the touch panel 56. The touch panel 56 is a touch input module, which is placed so as to cover the surface of the protective glass 42 on the front side of the main display 5. The touch panel 56 detects a position (touch position) that a finger of a player and other contact bodies touch, and enters input information corresponding to the touch position to the CPU 32. For example, the touch panel 56 enters information associated with selection of no figure displayed on the main display 5.

The image control circuit 81 controls image display both in the main display 5 and in the sub-display 4, and controls images to be displayed for a special lottery game, described later, for example.

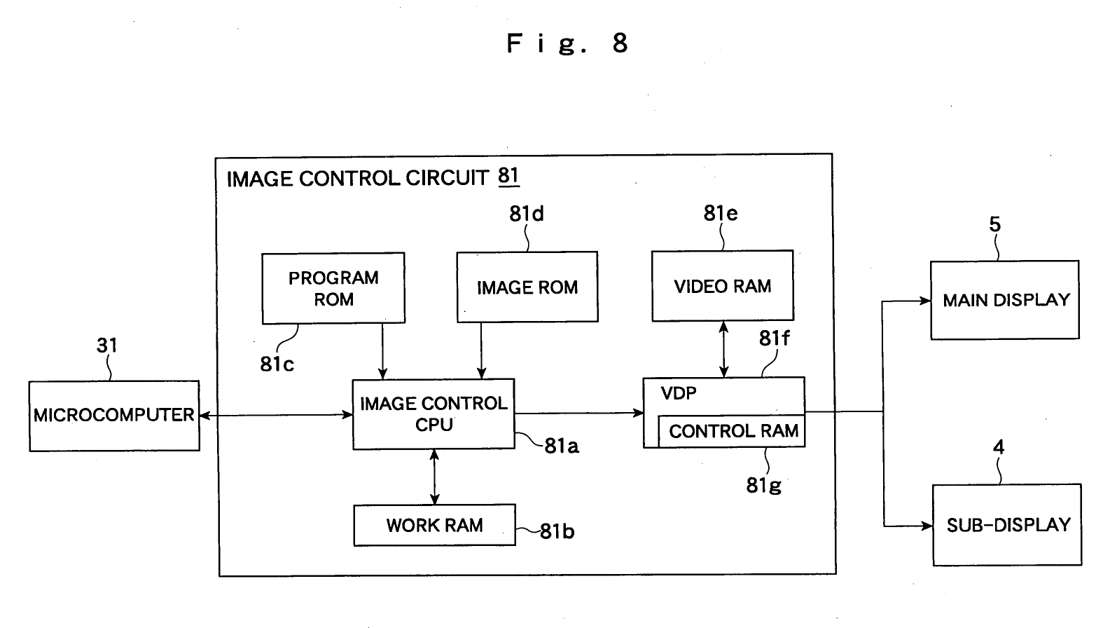

As shown in FIG. 8, the image control circuit 81 has an image control CPU 81a, work RAM 81b, program ROM 81c, image ROM 81d, video RAM 81e, and a VDP (Video Display Processor) 81f. The image control CPU 81a decides images to be displayed on the main display 5 and the sub-display 4 in accordance with an image control program (relating to display on the main display 5 and the sub-display 4) stored in the program ROM 81c beforehand based on the parameter set at the microcomputer 31. The work RAM 81b is configured as a temporary storage module when the image control CPU 81a runs the image control program.

The program ROM 81c stores the image control program and various selection tables therein. The image ROM 81d stores dot data for creating images therein. The video RAM 81e is configured as a temporary storage module when an image is created by the VDP 81f. The VDP 81f has control RAM 81g, creates an image in accordance with the display descriptions of each of the displays 4 and 5 decided by the image control CPU 81a, and outputs each created image to the individual displays 4 and 5.

(Configuration of the Figure)

As shown in FIG. 9, the figure 90 has the base part 91, a figure main body part 92, and the IC chip 93 stored the figure ID, etc., therein.

The base part 91 has the size corresponding to the base mount part 19a of the figure setting unit 19, having the configuration in which it is formed in a bottomed cylindrical shape having a top part 91a and the IC chip 93 is fit into the open end part.

The figure main body part 92 is configured to have a foot base part 92a fixed to the top part 91a of the base part 91 and a three-dimensional shape formed so as to erect from the foot base part 92a, and a doll part 92b shaped into a character such as a wizard, a warrior, etc.

In the embodiment, the figure 90 corresponds to a game item in the invention.

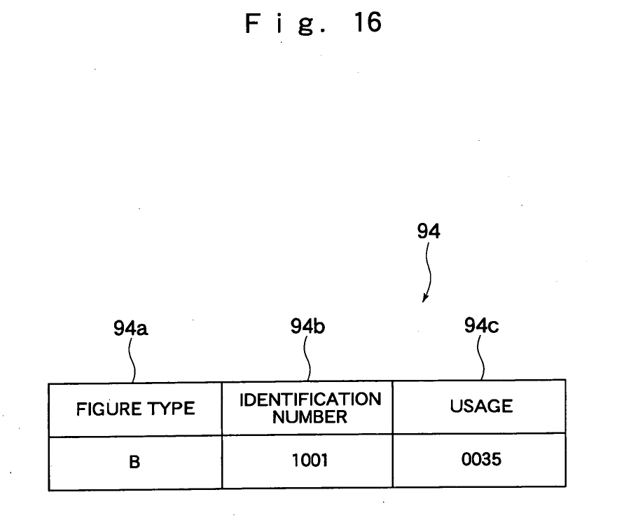

The IC chip 93 is a storage module, which stores a figure information record 94 as shown in FIG. 16. The figure information record 94 has each field, a figure type field 94a, an identification number field 94b, and a usage field 94c, each field stores data relating to the figure 90. The figure type means a type of figure corresponding to the three-dimensional shape of the figure main body part 92, and is distinguished by alphabet (for example, “A” is a wizard, “B” is a warrior, “C” is a villager, etc.). The identification number is a unique identification number that distinguishes each of the figures (it distinguishes oneself from another), and is formed of four digits of numeric data. In the embodiment, the figure ID is configured of the figure type and the identification number, and the figure ID corresponds to identification information in the invention. On the other hand, the usage represents the number of games done using the figure 90, described later, and is represented by four digits of numeric data. The usage is updated by the IC chip reader/writer 19c.

A player can distinguish the character type of the figure 90 by the three-dimensional shape of the figure main body part 92, and the slot machine 1A can distinguish each figure by the figure ID. In the case of the figure 90 shown in FIG. 9, the figure ID is “B1001” as shown in FIG. 16; “B” is the figure type, and “1001” is the identification number. Furthermore, the usage is “0035”.

(Operation Descriptions of the Slot Machine)

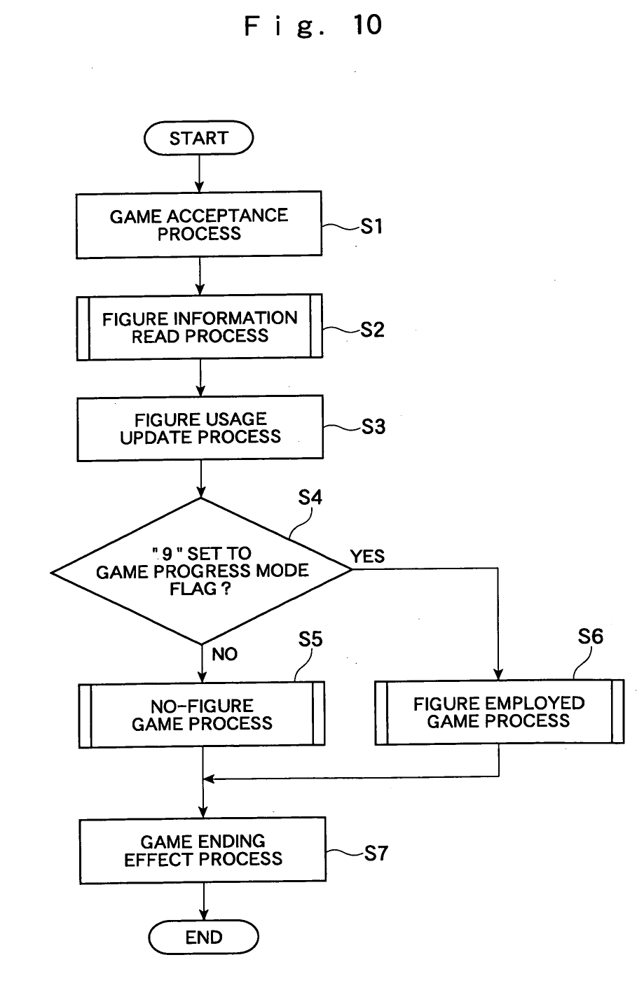

In the slot machine 1A according to the embodiment, the CPU 32 operates as a game progress control module in the invention, and advances a game in the first or second game progress mode. In the first game progress mode, a game can be moved in the base game state and the first special game state. On the other hand, in the second game progress mode, a game can be moved in the base game state and the second special game state. Hereinafter, the operation descriptions of the slot machine 1A will be described with reference to flow charts shown in FIGS. 10 to 15.

FIG. 10 is a flow chart illustrating the operation procedures of a main process of the slot machine 1A from the beginning to the end of a game as separated into each block. In addition, Step is abbreviated to S in FIGS. 10 to 15.

As shown in FIG. 10, when the main process is started, the slot machine 1A conducts a game acceptance process at Step 1 at the beginning of the game, it reads the figure ID stored in the IC chip 93 at subsequent Step 2, and it conducts a figure information read process that sets a game progress mode flag, described later, for determining the game progress mode. When the process is moved to subsequent Step 3, it conducts an update process (figure usage update process) that adds “1” to the usage stored in the IC chip 93 of the figure 90. At subsequent Step 4, the process is branched based on the game progress mode flag set at Step 2. In the first game progress mode, it is moved to Step 5 to conduct a no-figure game process, and in the second game progress mode, it is moved to Step 6 to conduct a figure employed game process. After each game processes is finished, a game ending effect process is done to end the main process. Hereinafter, the detail of each block will be described.

First, when the process is moved to the start acceptance process at Step 1, the slot machine 1A accepts an operation to start a game by a player in accordance with control by the CPU 32. Since the slot machine 1A is a coin insertion type game machine, in order to start a game by a player, the player first inserts coins for a bet on a single game from the coin insertion slot 6. When credits remain, the player manipulates any one of the single BET switch 9 and the maximum BET switch 10. Subsequently, the player manipulates the spin switch 8 (hereinafter, these manipulations are called ‘the start manipulation’). With the start manipulation, a start signal is inputted from the spin switch 8 to the CPU 32.

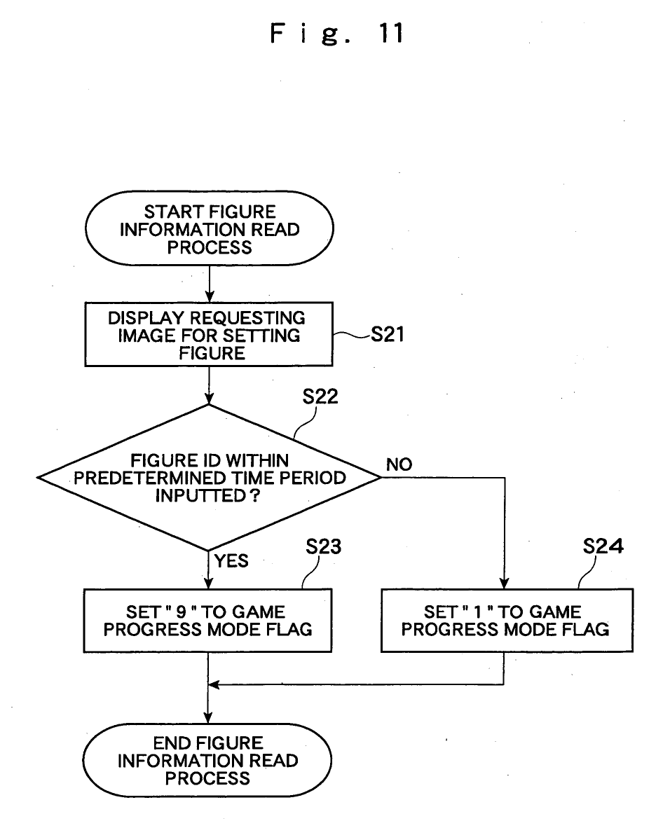

Then, the process is moved to at Step 2 to do the figure information read process. When the figure information read process is started, it is moved to Step 21 shown in FIG. 11, the CPU 32 instructs the image control circuit 81 to request for setting a figure on the main display 5, whereas to display an image that requests a player having no figure to select ‘no figure’ (hereinafter, it is called a ‘requesting image’). In accordance with the ‘requesting image’, a player having a figure 90 sets the figure 90 on the figure setting unit 19, whereas the player having no figure touches the touch panel 56 to select ‘no figure’. Then, when the figure 90 is set on the figure setting unit 19, the IC chip reader/writer 19c reads and enters the figure ID and the usage of the figure 90 to the CPU 32, and the figure ID, etc. are temporarily stored in the RAM 33. In the embodiment, since the figure 90 is read, the figure ID inputted to the CPU 32 is “B1001”, and the usage is “0035”. On the other hand, when ‘no figure’ is selected, corresponding input information corresponding to that selection is inputted from the touch panel 56 to the CPU 32.

When the process is moved to subsequent Step 22, the CPU 32 operates as a read determining module in the invention to determine whether or not to have read the figure ID. At this time, it is determined that the figure ID has been read when the IC chip reader/writer 19c enters the figure ID, and the process is moved to Step 23. When the figure ID is not inputted within a predetermined period in time, and when the touch panel 56 enters corresponding input information corresponding to the selection of ‘no figure’, it is determined that the figure ID has not been read, the process is moved to Step 24.

When the process is further moved to Step 23, the CPU 32 sets a predetermined item of information (for example, “9”) to the game progress mode flag that represents either the first or second game progress mode to end the figure information read process. On the other hand, when the process is moved to Step 24, the CPU 32 sets a predetermined item of information (for example, “1”) to the game progress mode flag to end the figure information read process. In this manner, in the slot machine 1A, the game progress mode flag is set to “9” or “1”, the game progress mode flag is mode determination information which determines the game progress mode as either the first or second game progress mode at subsequent Step 4 based on whether or not to have read the figure ID.

Subsequently, the process is moved to Step 3 shown in FIG. 10, and the figure usage update process is done. In the figure usage update process, the CPU 32 operates as an update module, it instructs the IC chip reader/writer 19c to read the usage stored in the IC chip 93 of the figure 90, it adds “1”, and then it conducts the update process. In the embodiment, since the usage of the figure 90 is “0035” as described above, the update process is done to add “1” for “0036”. In this manner, since the usage is added with “1” every time when the start signal is inputted to the CPU 32 by the start manipulation and when the figure ID is inputted, it corresponds to the number of games done using the figure 90.

At subsequent Step 4, the CPU 32 operates as a mode determining module to determine the game progress mode based on whether or not to have read the figure ID. At this time, the CPU 32 determines whether “9” is set to the game progress mode flag, and branches the process at Steps 5 and 6 in accordance with the determined result. More specifically, when “9” is set to the read flag, it determines the mode as the second game progress mode to Step 6, whereas it determines the mode as the first game progress mode other than that (“1” is set) to branch the process to Step 5.

Then, in the slot machine 1A according to the embodiment, the descriptions of the game played in the second game progress mode determined by having read the figure ID are more advantageous for a player than the game played in the first game progress mode. In the description below, the process when the second game progress mode is determined will be first described, and then the process when the first game progress mode is determined will be described.

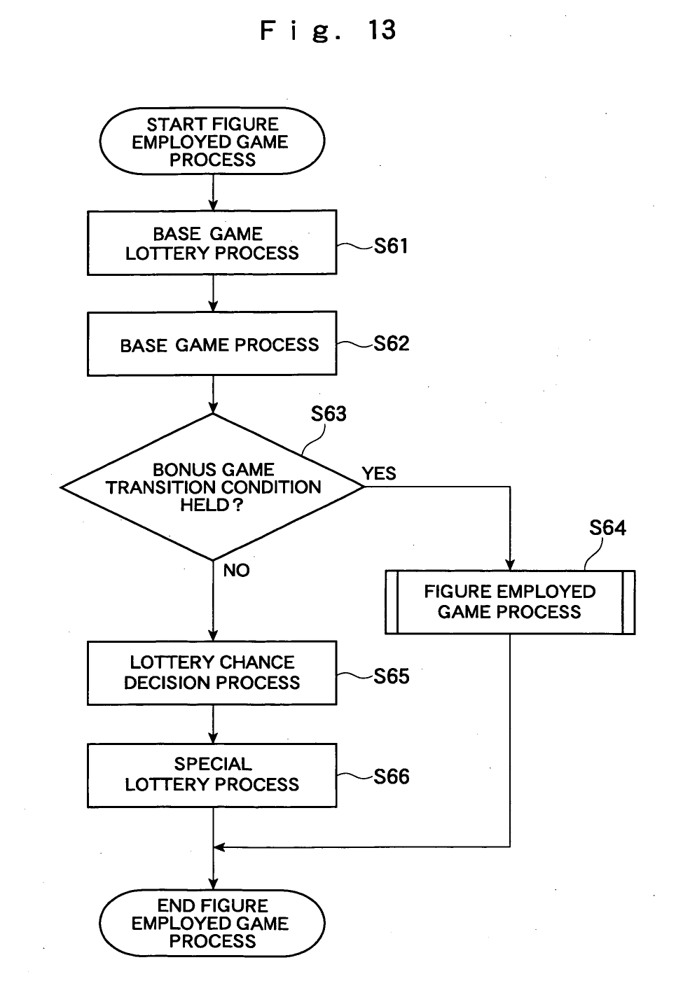

In the second game progress mode, the process is moved to Step 6 shown in FIG. 10, and the figure employed game process is done. When the figure employed game process is started, the process is moved to Step 61 shown in FIG. 13, and a base game lottery process is done as the game state stays in the base game state. In the base game lottery process, the CPU 32 first conducts a motif decision process that a motif to be stopped at the pay line L1 is decided for each of the reels 3L, 3C, and 3R.

In this case, when the CPU 32 detects player's start manipulation by the start signal from the spin switch 8, it instructs the random number generator 35 to generate random numbers within a predetermined range, and it instructs the sampling circuit 36 to extract a given random number among the random numbers generated by the random number generator 35. When a random number is extracted, the CPU 32 sets that random number to a search key, it references to a motif decision table stored in the ROM 34 (a table that associates the code numbers of motifs with random numbers), not shown, and it obtains the code number of the relevant motif.

Then, it sets the obtained code number to the search key, it references to a stop table, not shown, and it retrieves a motif to be displayed on the valid line for each of the reels 3L, 3C, and 3R when stopped. In addition, the stop table is a table that stores and associates each motif with the code number of motifs and can set the code number to the search key to retrieve the relevant motif for each of the reels 3L, 3C, and 3R.

In the slot machine 1A, the extraction of the random number and search for the motif decision table and for the stop table are done for each of the reels 3L, 3C, and 3R for three times in total, that is, they are done for times corresponding to the number of the reels. Subsequently, the motif is decided for each of the reels 3L, 3C, and 3R, and then the stop position of the reel is decided to stop the motif on the pay line L1.

When the stop position of the reel is decided, the CPU 32 references to a winning determination table stored in the ROM 34 (a table that resisters as it can distinguish the combination of winning motifs between the combination of loser motifs (no win) in association with the combination of the individual code numbers (hereinafter, it is called a ‘code number pattern’)), and it uses the code number pattern to do a winning determination process that determines whether or not to have won.

Subsequently, the CPU 32 references to a mode table that re sisters payouts in accordance with each winning mode, and conducts a winning mode determination process that determines winning modes (the ‘winning mode’ is also called a ‘combination’). In the mode table, for example, when a combination ‘joker (a motif depicted by W1 in FIG. 2)’ appears, the game state is moved from the base game state to the second special game state, and when ‘3BAR-3BAR-3BAR’ appears that three motifs having three ‘BAR's vertically placed are arranged (3 BAR: a motif depicted by W2 in FIG. 2), five coins are paid out.

As described above, the base game lottery process is ended. When the process is moved to subsequent Step 62, the base game process is done. Here, each of the reels 3L, 3C, and 3R is rotated, and then they are stopped as corresponding to the result of the base game lottery at Step 61. When the player has won, coins are paid out based on a payout in accordance with the winning mode.

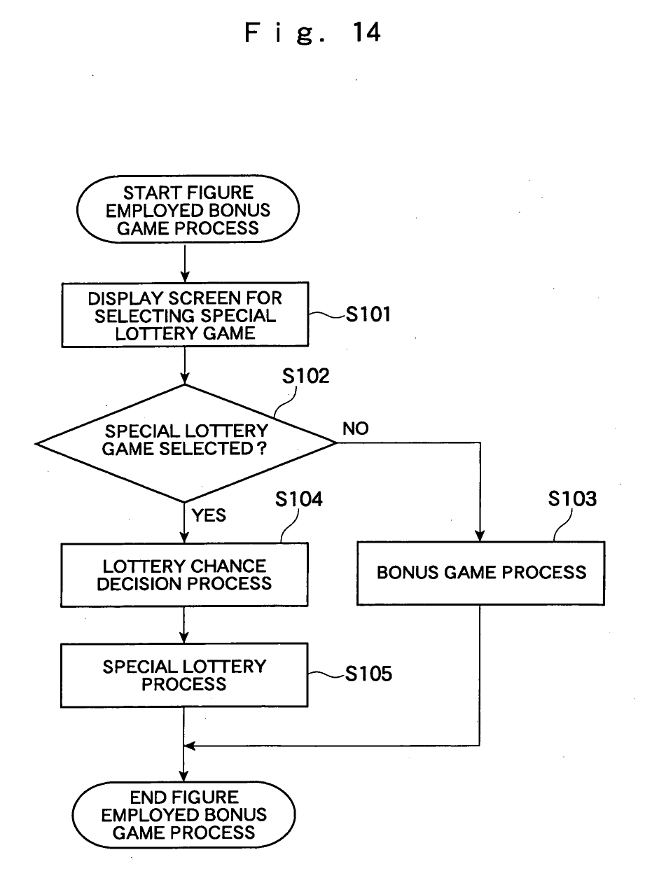

When the process is moved to subsequent Step 63, from the result of the base game lottery process at Step 61, the CPU 32 determines whether or not to hold a transition condition to the bonus game (whether or not to hold a transition condition from the base game state to the second special game state). Here, when the transition condition is held, the CPU 32 operates as a transition module to move the game state from the base game state to the second special game state, and the process is moved to Step 64 for the figure employed bonus game process. On the other hand, when the transition condition is not held, the process is moved to Steps 65 and 66 for the same processes as a lottery chance decision process (see Step 104 in FIG. 14), and a special lottery process (see Step 105 in FIG. 14), described later, to end the figure employed game process.

### FIRST EXAMPLE OF THE FIGURE EMPLOYED BONUS GAME PROCESS

FIG. 14 is a flow chart illustrating the operation procedures of a first example of the figure employed bonus game. When the figure employed bonus game process is started, the process is moved to Step 101 shown in FIG. 14. The CPU 32 instructs the image control circuit 81 to display an image requesting for selection whether or not to do a special lottery game on the main display 5 (hereinafter, it is called a ‘select request image’). The player can touch the touch panel 56 to select whether or not to do a special lottery game in accordance with the ‘select request image’. When the player references to the select request image and touches the touch panel 56, corresponding input information corresponding to that touch is inputted from the touch panel 56 to the CPU 32.

When the process is moved to subsequent Step 102, the CPU 32 determines whether or not to do a special lottery game. When corresponding input information indicates that the special lottery game is not done, the process is moved to Step 103 for a bonus game process. When it indicates that the special lottery game is done, the process is moved to Step 104 for a lottery chance decision process.

In the bonus game process (Step 103), free games are done for a predetermined number of times (for example, three times). Therefore, when the bonus game process is started, the same processes as the motif decision process, the winning determination process, and the winning mode determination process in the base game lottery process are done for a predetermined number of times to play free games. Then, based on the lottery result, each of the reels 3L, 3C, and 3R is rotated and stopped for a predetermined number of times. When the player has won, coins are paid out based on a payout in accordance with the winning mode to end the figure employed bonus game process. In addition, the bonus game process done herein is the same as the bonus game process done in the first game progress mode as described later.

On the other hand, when the process is moved to Step 104 to do the lottery chance decision process, the CPU 32 obtains the figure type (“B” in the figure 90), the identification number (“1001” in the figure 90), etc., from the figure ID stored in the RAM 33, and it uses the identification information to decide special lottery chances. For example, special lottery chances may be decided based on the extracted numbers by extracting the number in each digit stored as identification numbers at random, or special lottery chances may be decided in which a type correspondence table that associates the figure type with special lottery chances is stored in the ROM 34, and the figure type is obtained from the read figure ID to reference to the type correspondence table.

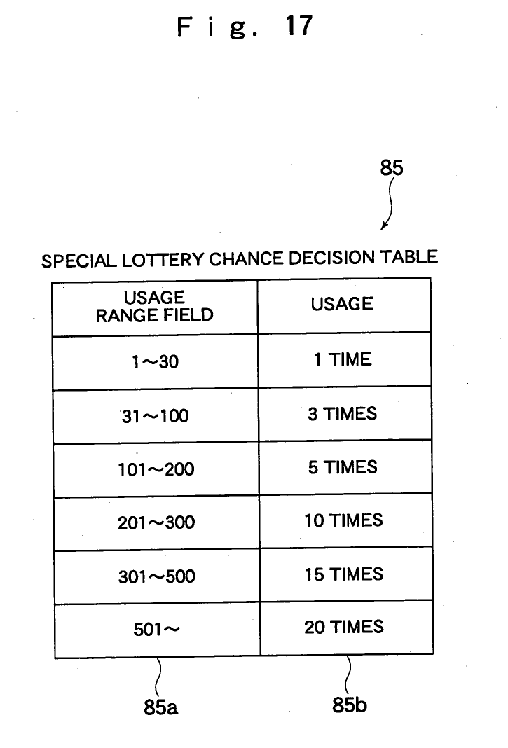

Furthermore, the CPU 32 may obtain the usage corresponding to the figure ID, reference to a special lottery chance decision table 85 (FIG. 17) stored in the ROM 34, and decide special lottery chances. The special lottery chance decision table 85 has a usage range field 85a and a special lottery chance field 85b that stores and associates special lottery chances with the usage distinguished by the usage range field 85a. For example, the usage read in the embodiment is “0035” that has read before the figure usage update process (see Step 3 in FIG. 10), and data corresponding to the usage is “35”. Then, “35” is set to the search key, and the usage field 85a in the special lottery chance decision table 85 is referenced to decide special lottery chances as three times.

When the process is moved to subsequent Step 105, the special lottery process is done. In the special lottery process, the CPU 32 instructs the random number generator 35 to extract a given random number among the random numbers generated by the random number generator 35. When a random number is extracted, the CPU 32 sets that random number to the search key, and references to a wining decision table, not shown, stored in the ROM 34. When the player has won, a predetermined number of coins is paid out (for example, 20 coins). The wining decision table is registered with wining numbers and loser numbers that are distinguishable and associated with the extracted random numbers. When the CPU 32 conducts the special lottery process described above by the special lottery chances decided at Step 104, the special lottery process is finished to end the figure employed bonus game process. In addition, during the special lottery process, the CPU 32 instructs the image control circuit 81 to display effects for the special lottery game on the main display 5. For example, an effect image that a soccer player makes a penalty kick may be displayed; the ball is carried to a goal when the player has won, whereas the keeper saves the ball when lost. Alternatively, an effect image that a dart is thrown toward a dart board may be displayed; the dart is hit at the center of the dart board when the player has won.

In this manner, in the embodiment, the usage corresponding to identification information is used to do a second special game (special lottery game).

### SECOND EXAMPLE OF THE FIGURE EMPLOYED BONUS GAME PROCESS

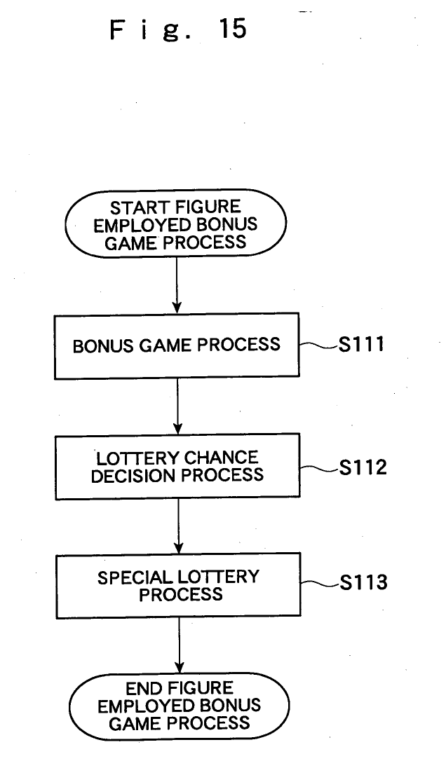

FIG. 15 is a flow chart illustrating the operation procedures of a second example of the figure employed bonus game. When the figure employed bonus game process of the second example is started, the process is moved to Step 111 in FIG. 15, and the same bonus game process as the bonus game process described above (Step 103 in FIG. 14) is done. After that, the process is moved to subsequent Steps 112 and 113, the lottery chance decision process described above, the same lottery chance decision process as the special lottery process described above (Steps 104 and 105 in FIG. 14), and the special lottery process are done, and the figure employed bonus game is ended. As described above, in the figure employed bonus game process of the second example, the special lottery game is added after the bonus game without requesting a player for selection whether or not to do a special lottery game, different from the first example. Thus, the player can enjoy both the bonus game and the special lottery game, which can generate motivation to repeatedly play games.

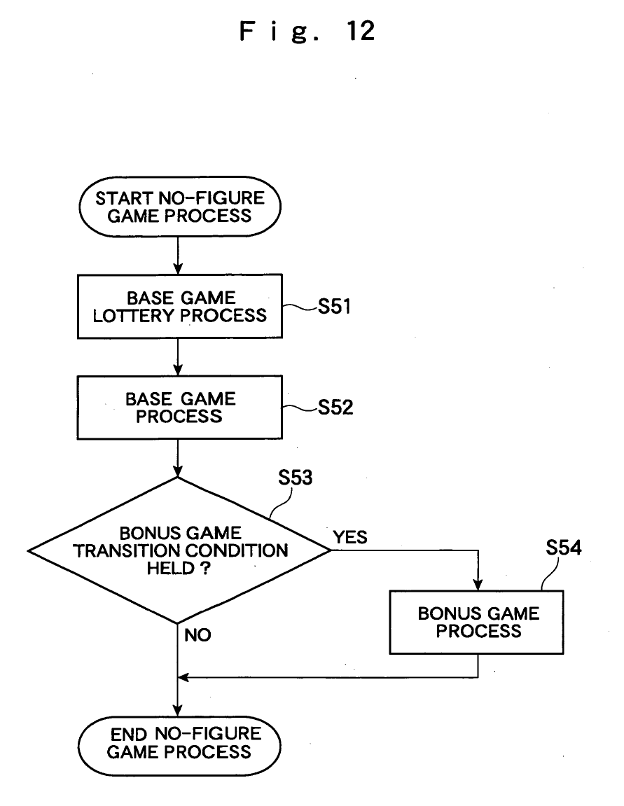

On the other hand, in the first game progress mode, the process is moved to Step 5 in FIG. 10 to do the no-figure game process. When the no-figure game process is started, the process is moved to Steps 51 and 52 in FIG. 12, the game state stays in the base game state as similar to at Steps 61 and 62 described above (see FIG. 13), and the base game lottery process and the base game process are done. The base game lottery process in this case may be the same as or different from the base game lottery process done in the second game progress mode. Then, when the process is moved to subsequent Step 53, the CPU 32 determines whether or not to hold the transition condition to a bonus game (whether or not to hold the transition condition from the base game state to the first special game state) by the result from the base game lottery process at Step 51. Here, when the transition condition is held, the CPU 32 operates as the transition module to move the game state from the base game state to the first special game state, and the process is moved to Step 54 for the bonus game process. In the bonus game process Step 54, the same process is done as the bonus game process done in the second special game state described above, and a predetermined number of free games (for example, three games) is done as the first special game. After that, the no-figure game process is ended.

As described above, when the no-figure game process (Step 5) or the figure employed game process (Step 6) in FIG. 10 is finished, the process is moved to step 7 for the game ending effect process. Here, for example, by the usage obtained from the figure ID read in the figure information read process at Step 2, the special lottery chance decision table 85 (See FIG. 17) is referenced to decide special lottery chances. Then, an image that shows the obtained usage and the special lottery chances is displayed to notify the player, which provides motivation to repeatedly play games. In addition, in the game ending effect process, the figure ID stored in the RAM 33 is deleted to clear the game progress mode flag.

As described above, the slot machine 1A can prepare the first and second game progress modes determined based on whether or not to have read the figure ID, and can play the second special game using the figure ID read from the figure 90 in the second game progress mode. Therefore, since it uses the figure to allow the game to be played in the second game progress mode different from the first game progress mode that is only done with no figure, the variations of the special game are expanded, and the player is hardly bored even though the player repeatedly plays games. Furthermore, in the first and second game progress modes, since games are done independently, the descriptions of the second special game done in the second game progress mode can be changed and the condition that moves the base game state to the second special game state can be changed easily without changing the game descriptions done in the first game progress mode. The expandability of the overall game descriptions is improved. Moreover, since the second special game is done using the figure ID in the second game progress mode, a figure is required to play the bonus game, and motivation is provided to repeatedly use a figure.

Besides, in the slot machine 1A, since a figure is changed to cause a figure ID to be changed and then the descriptions of the second special game using that the figure ID are changed, the expandability of the game descriptions is increased. Furthermore, when the usage of the figure ID is used to allow the second special game (special lottery game), even the same figure is used, the figure is repeatedly used to change the usage, and the descriptions of the second special game are varied in accordance with that usage. Particularly, since the usage is increased to provide more advantageous descriptions, motivation can be provided for the player to repeatedly use a figure.

In addition, in the slot machine 1A, the special lottery game (see Steps 65 and 66 FIG. 13) corresponding to the second special game is done even though no bonus game transition condition is held in the figure employed game process. Therefore, the player to use a figure 90 can play a bonus game and a special lottery game when the bonus game transition condition is held, whereas the player can play a special lottery game even though the bonus game transition condition is not held, which can provide motivation for the player to repeatedly use the figure.

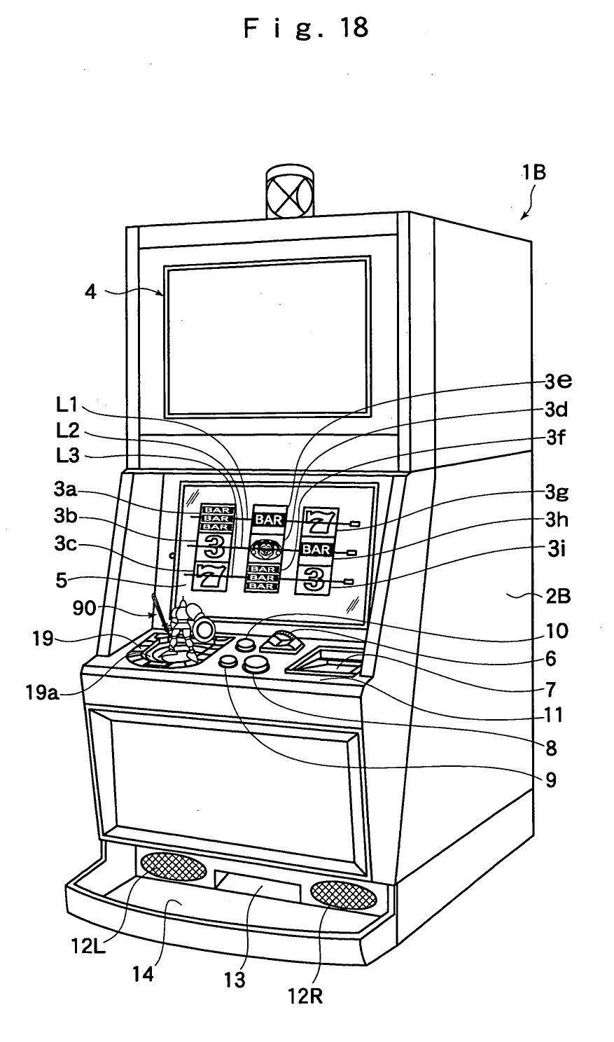

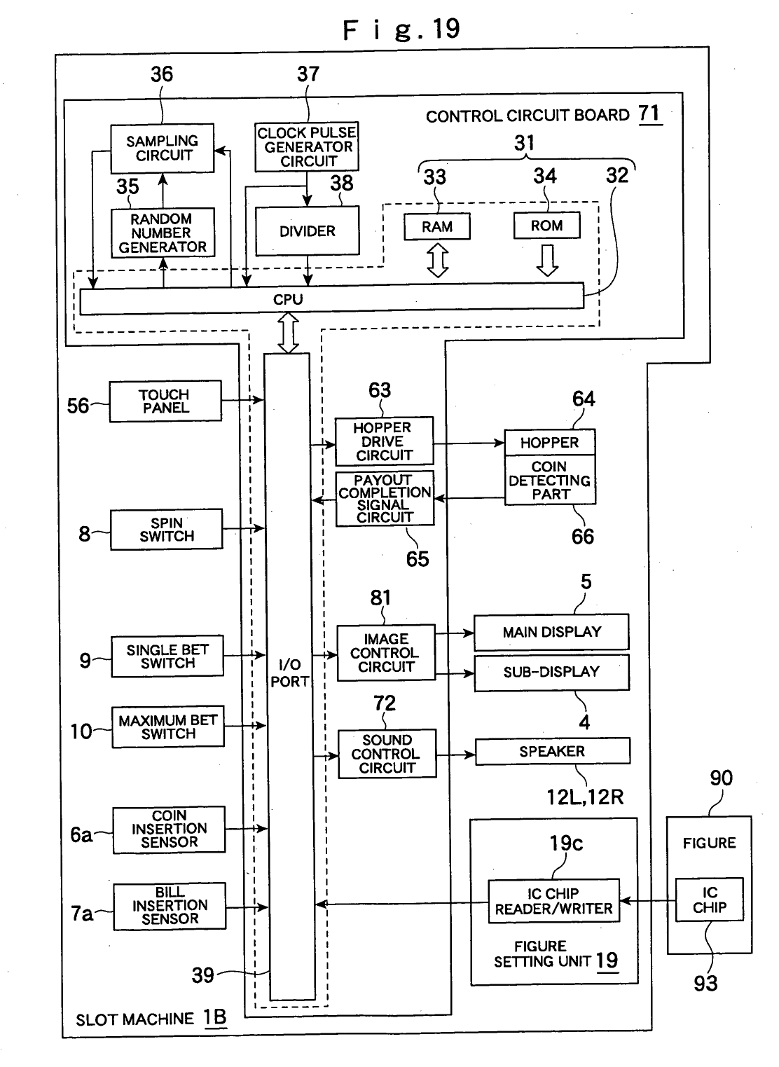

Next, a slot machine 1B according to a second embodiment will be described with reference to FIG. 18. FIG. 18 is a perspective view illustrating the overall configuration of the slot machine 1B according to the embodiment, and FIG. 19 is a block diagram mainly illustrating the internal configuration of the slot machine 1B.

In the slot machine 1B, motifs depicted on the outer surfaces of the reels 3L, 3C, and 3R of the first embodiment described above are shown on the main display 5 as variable display motifs. More specifically, the slot machine 1B has multiple columns of variable display parts (three columns) which display variable display images of multiple motifs, instead of the reels 3L, 3C, and 3R of the slot machine 1A, and is configured to play a variable display image game (video slot game) using variable display images displayed in each variable display part. Furthermore, as similar to the slot machine 1A, the slot machine 1B can also play games in the first game progress mode and the second game progress mode, and in which game progress mode a game is played is decided depending on whether or not to have read the figure ID. However, in the slot machine 1B, a labyrinth combat image game, described later, and the special lottery game described above are played in the second special game state, not the free game. Hereinafter, the configuration of the slot machine 1B will be described, but the configuration of the slot machine 1B is substantially common with that of the slot machine 1A. Therefore, substantially the same components are assigned the same numerals and signs as those of the slot machine 1A, omitting the detailed description.

A main display 5 of the slot machine 1B has nine variable display parts 3a, 3b, 3c, 3d, 3e, 3f, 3g, 3h, and 3i in total, arranged in three columns and three rows. In the main display 5, in the base game state (the base game) and the first special game state (free game), scroll display images that multiple motifs are moved from above to below (the reel image that is shown as if the mechanical reels are rotated) are displayed as variable display images on each of the variable display parts 3a to 3i. In addition, in FIG. 18, three valid lines (L1 to L3) are set vertically, but eight valid lines on each of the variable display parts 3a to 3i in three rows and three columns and diagonal lines.

As shown in FIG. 19, the slot machine 1B has multiple components as a microcomputer 31 is centered. A CPU (Central Processing Unit) 32 operates as the read determining module, the mode determining module, and the game progress control module which moves games in the first and second game progress modes in the invention, and an IC chip reader/writer 19c corresponds to the reading module.

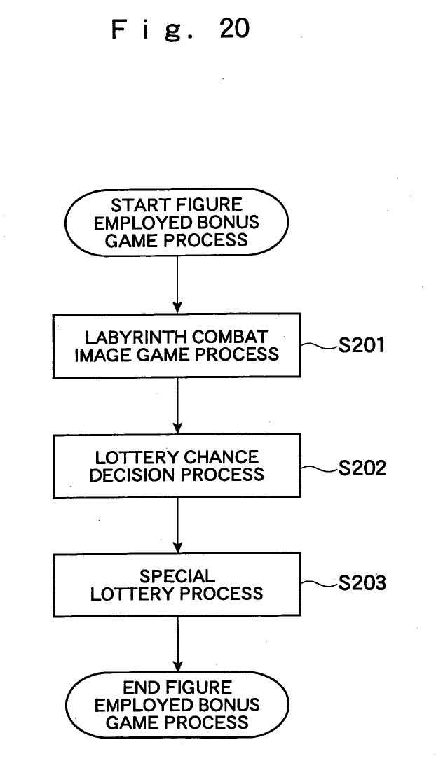

Next, the operation descriptions of the slot machine 1B will be described. A main process of the slot machine 1B is substantially the same as that of the slot machine 1A, but the figure employed bonus game process (see FIG. 14) is different. Then, a figure employed bonus game process will be described with reference to FIG. 20. In addition, FIG. 20 is a flow chart illustrating the operation procedures of the figure employed bonus game process in the slot machine 1B. In addition, in FIG. 20, Step is abbreviated to S.

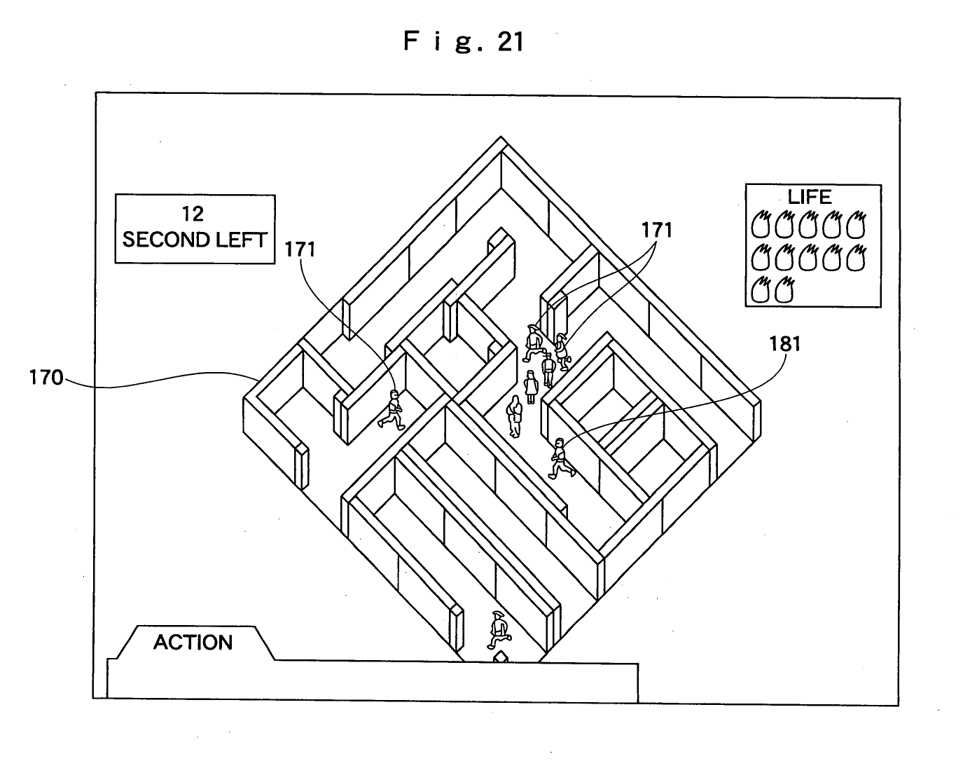

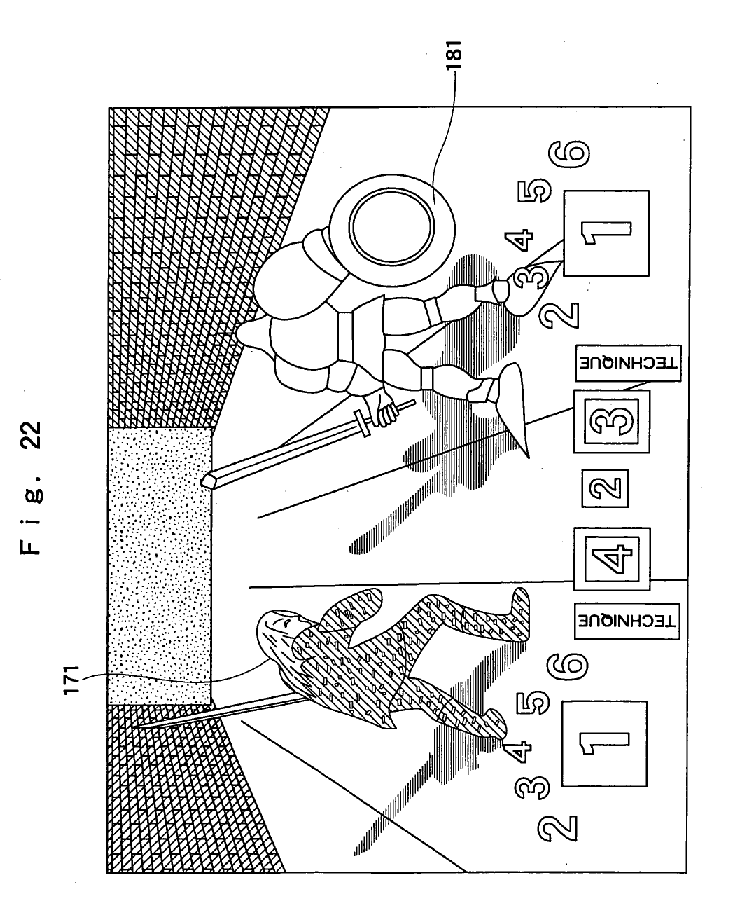

When the figure employed bonus game process is started, the process is moved to Step 201 in FIG. 20, and the CPU 32 conducts a labyrinth combat image game process. In the embodiment, the labyrinth combat image game and a special lottery game, described later, correspond to the second special game. For example, the labyrinth combat image game is a game in which a character 181 manipulated by a player moves in a labyrinth 170 shown in FIG. 21, it combats against another character 171 different from that character (a no-manipulation character that is operated by the CPU 32), it fights for a treasure item held by the character 171, and it collects all the items to conquer a character 171 of the final target. In the labyrinth combat image game, the score of each of the characters (it is called ‘life’ in the embodiment) is up and down in accordance with the combat result and conditions of progress in the game. When the score is all gone or the character 171 of the final target is conquered, the combat image game is ended, and the process is moved to Step 202. Furthermore, in the embodiment, the image 181 that represents the character manipulated by the player is decided in accordance with a figure type and an identification number in the figure ID, which corresponds to the figure main body part 92 of the figure 90, as shown in FIG. 22. FIG. 22 is an image illustrating that a character 181 manipulated by a player is fighting against a combat opponent 171. In this manner, in the embodiment, the figure ID (identification information) is used to play the second special game. Particularly, since the image of the character 181 manipulated by a player is matched with the shape of the figure 90, the player can enjoy the game as the figure 90 set on the figure setting unit 19 is associated with the labyrinth combat image game (second special game), and the player can enjoy games with realistic sensations.

Furthermore, in the embodiment, a table may be placed in RAM 33, the table stores and associates the usage of the figure ID with items that can be worn by a character appeared in the second special game such as the labyrinth combat image game, and the items that can be morn by the character may be varied in accordance with the usage. Moreover, the items that can be morn by the character may become stronger in accordance with an increase in the usage (offence and defense become stronger). When this is done, the usage is used to play the second special game, and the player is urged to repeatedly use the figure 90 to improve willingness to collect figures.

At subsequent Steps 202 and 203, as similar to Steps 104 and 105 in the slot machine 1A (see FIG. 14), a lottery chance decision process and a special lottery process are done to end the figure employed bonus game process.

As described above, the slot machine 1B also exerts the same effects and advantages as those of the slot machine 1A, and the variations of the bonus game are widened. Even though a player repeatedly plays games, the player is hard to be bored with games, and the expandability of the overall game descriptions is enhanced.

As described above, in the slot machines 1A and 1B according to the first and second embodiments, the mode is described that the usage of the figure 90 is stored in the IC chip 93 of the figure 90. However, a usage management file may be stored in the RAM 33 of each of the slot machines 1A and 1B, and the usage of the figure 90 may be stored by the usage management file. For example, it may be configured in which only a figure ID is stored in the IC chip 93 of the figure 90 and the usage management file has each field (a figure ID field and a usage field) that stores and associates the figure ID and the usage. Then, an IC chip reader/writer 19c reads the figure ID, the CPU 32 operates as an update module, the figure ID is set to a search key, and the relevant record is retrieved. When the relevant record exists, an update process is done that the numeric of the usage field of that record is added with “1”. When the relevant record does not exist, that figure is considered to be used for the first time, and the CPU 32 generates a new record that turns the numeric of the usage field to “1”. On the other hand, when the usage is obtained, the figure ID is set to the search key, and the figure ID field is referenced to obtain the relevant usage. Moreover, in the case of this mode, it may be an IC chip reader that can read only figure IDs, not the IC chip reader/writer.

Besides, in the slot machines 1A and 1B, the CPU 32 operates as the game progress control module. However, it may be configured in which the variable display game in the base game state in the second game progress mode is finished to start the second special game regardless whether or not to hold the transition condition to a bonus game. When such the configuration is made, a second special game different from the first special game can be done after moved to the second game state. The player using the figure 90 can be more amused, which provides motivation to use the figure 90 to repeatedly play games.

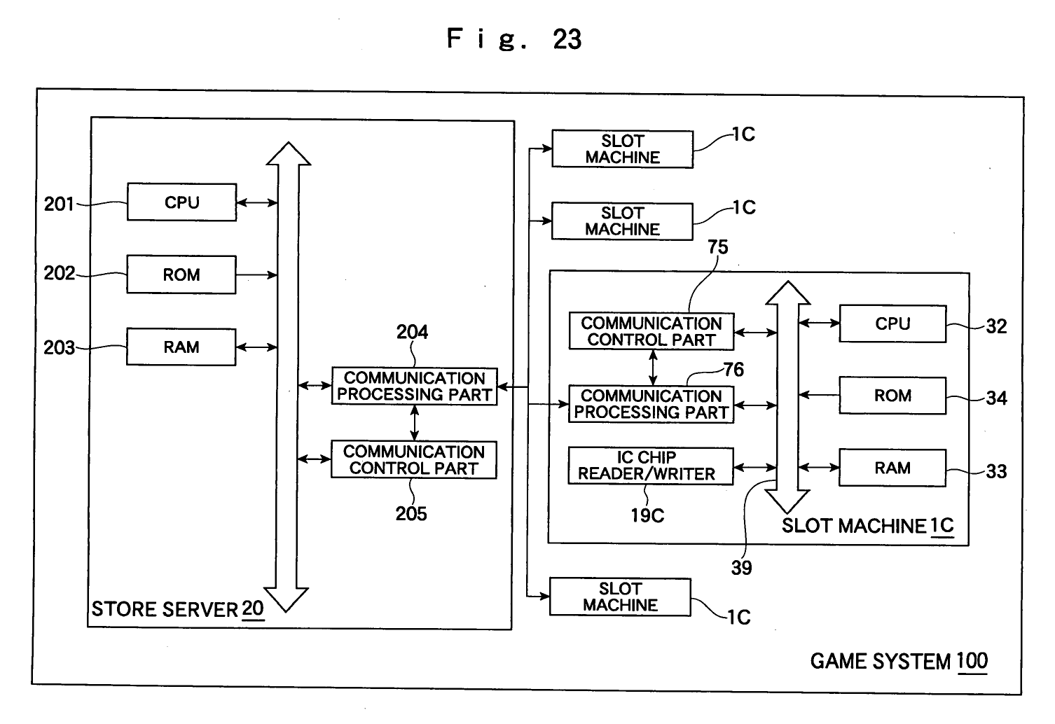

Next, an embodiment of a game system according to the invention will be described. FIG. 23 is a block diagram illustrating the schematic configuration of the game system according to the embodiment. A game system 100 has a store server 20 placed in a game store and multiple slot machines 1C (four machines in the embodiment) which are connected to the store server 20 as communication is allowed. In the game store, the store server 20 is connected to each of the slot machines 1C with dedicated lines to form an in-store LAN.

The store server 20 corresponds to a game server in the invention, and the slot machine 1C corresponds to the game machine. The slot machine 1C has a variable display module which variably displays multiple motifs as similar to the slot machine 1A according to the first embodiment, which is configured to play a slot game using variable display of multiple motifs by the variable display module.

In addition, the slot machine 1C may have variable display parts which display variable display images of multiple motifs in multiple columns (three columns) as the slot machine 1B according to the second embodiment described above, and a variable display image game (video slot game) is played using variable display images displayed in each of the variable display parts. In this case, the game machine has a communication processing module which sends and receives data with the game server, the CPU 32 operates as the read determining module, the mode determining module, and the game progress control module, and an IC chip reader/writer 19c corresponds to the reading module.

The store server 20 has a CPU 201, ROM 202, RAM 203, a communication processing part 204, and a communication control part 205. The RAM 203 stores a usage management file therein. The communication processing part 204 corresponds to the communication processing module of the game server in the invention.

The CPU 201 operates in accordance with a program stored in the ROM 202 while reading and writing data to the RAM 203, whereas the communication control part 205 operates the communication processing part 204 in accordance with the instruction by the CPU 201 to send and receive data with the slot machines 1C. Furthermore, the CPU 201 generates and updates records in the usage management file based on the figure ID sent from each of the slot machines 1C. The same usage management file described above is fine, and the file has a record formed of a figure ID field and a usage field. Data recorded in the record corresponds to usage information in the invention.

The slot machine 1C substantially has the same configuration of the slot machine 1A, but it is different from the slot machine 1A described above in that it has a communication control part 75 and a communication processing part 76. Therefore, the same numerals and signs are used for the same configuration, omitting the description. The communication control part 75 and the communication processing part 76 are connected to the CPU 32 through an I/O port 39, and the communication control part 75 operates the communication processing part 76 in accordance with the instruction by the CPU 201 to send and receive data with the store server 20. The communication processing part 75 corresponds to the communication processing module of the game machine in the invention. Moreover, as similar to the slot machine 1A as described above, the slot machine IC also has a CPU 32, a figure setting unit 19, an IC chip reader/writer 19c, etc. The CPU 32 corresponds to the game progress control module, the read determining module, and the mode determining module in the invention, and the IC chip reader/writer 19c corresponds to the reading module. In addition, only the figure ID is stored in an IC chip 93 of a figure 90 in the game system 100, and the usage is not stored therein.

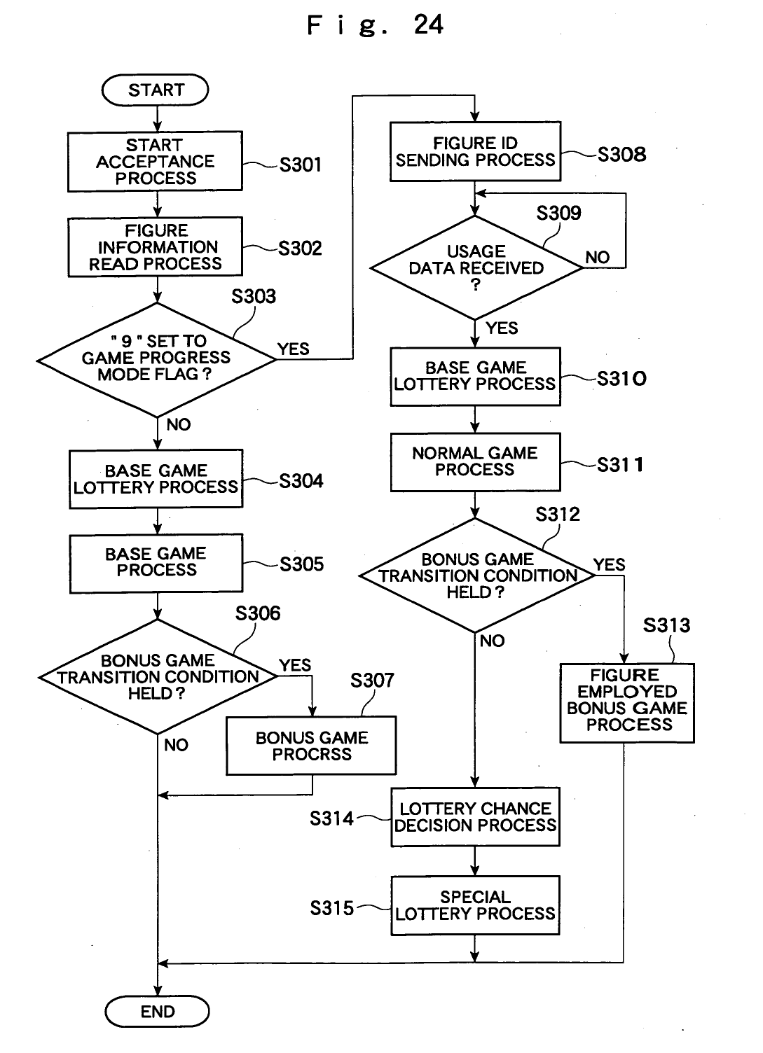

The operation descriptions of the game system 100 having the configuration will be described with reference to a flow chart shown in FIG. 24 as the operation of the slot machine 1C is centered. In addition, FIG. 24 is a flow chart illustrating the operation procedures of the slot machine 1C in a main process from the beginning to the end of a game. Among multiple slot machines 1C in the game store, a single machine will be taken and described. Furthermore, in the description below, for the same operation descriptions of each process explained in the slot machine 1A, the same process names are used to omit the detailed description. Moreover, Step is abbreviated to S in FIG. 24.

In the game system 100, the CPU 32 of the slot machine 1C operates as the game progress control module in the invention to control progress in a game. Then, as shown in FIG. 24, when the main process is started, a start acceptance process is done at Step 301 at the beginning of the game. At subsequent Step 302, a figure information read process is done, and the process is moved to Step 303. In the figure information read process, the IC chip reader/writer 19c reads the figure ID of the figure 90 set on the figure setting unit 19, the read figure ID is inputted to the CPU 32 by the IC chip reader/writer 19c, and temporarily stored in the RAM 33. In the figure information read process at Step 302, the CPU 32 operates as the read determining module. When the figure ID has been inputted, it is determined that the figure ID has been read to set “9” to a game progress mode flag. When the figure ID has not been inputted (for example, ‘no figure’ has been selected), it is determined that the figure ID has not been read to set “1” to the progress mode flag.

When the process is moved to Step 303, the CPU 32 operates as the mode determining module, and the process is branched to Step 308 or 309 depending on whether “9” is set to game progress mode flag. When “9” is set, it is determined as the second game progress mode to move to Step 308, otherwise (“1” is set) it is determined as the first game progress mode to move to Step 304. At Steps 304 and 305, the base game lottery process and the base game process are done. At subsequent Step 306, it is determined whether or not to hold a transition condition to a bonus game (whether or not to hold a transition condition from the base game state to first special game mode). At Step 306, when it is determined that the transition condition is held, the process is moved to Step 307 for the bonus game process to end the main process, whereas it is determined that the transition condition is not held, the game progress mode flag is cleared to end the main process.

On the other hand, when the process is moved to Step 308, a figure ID sending process is done. When the figure ID sending process is started, the CPU 32 instructs the communication control part 75 to send the figure ID stored in the RAM 33 from the communication processing part 76 to the game server 20. When the figure ID is received at the game server 20, the CPU 201 operates as the update module to do a usage generation and update process that generates and updates records in the usage management file stored in the RAM 203. In the usage generation and update process, the CPU 201 sets the sent figure ID to the search key, and references to the usage management file to retrieve the relevant record. When the relevant record exists, an update process is done that “1” is added to the numeric of the usage field of that record. When the relevant record does not exist, that figure is considered to be used for a first time, the CPU 201 generates a new record that turns the numeric of the usage field of that record to “1”. After that, the CPU 201 of the game server 20 obtains data about the usage corresponding to the received figure ID, and it instructs the communication control part 205 to send data about the obtained usage from the communication processing part 204 to the slot machine 1C. In addition, the usage sent from the game server 20 is the usage after the CPU 201 has operated as the update module for the update process.

In the slot machine 1C, it waits until it receives data indicating the usage (usage data) at Step 309. When it receives usage data, that usage data is inputted from the communication processing part 76 to the CPU 32 and stored in the RAM 33. When the process is moved to subsequent Steps 310 and 311, a base game lottery process and a base game process are done. When the process is moved to subsequent Step 312, it is determined whether or not to hold the transition condition to a bonus game (whether or not to the hold transition condition from the base game state to the second special game state). When it is determined that the transition condition is held, the process is moved to Step 313 for a figure employed bonus game process. In the figure employed bonus game process, as similar to the first and second examples described above, a bonus game and a special lottery game are done. Furthermore, for the bonus game, a free game with no bet and a labyrinth combat image game are done by a player, and the bonus game may be the same as the bonus game played at Step 307. Moreover, in such the bonus game, the probability of winning a free game may be increased based on the usage stored in the RAM 33, or the number of items obtained in the labyrinth combat image game may be increased or decreased.

On the other hand, when the bonus game transition condition is not held, no bonus game is played but only a special lottery game is played. More specifically, when the process is moved to Step 314 for the lottery chance decision process, the usage data received from the game server 20 is set to the search key, and the special lottery chance decision table stored in the RAM 33 is referenced to decide special lottery chances. Then, when the process is moved to subsequent Step 315, the special lottery games for the decided special lottery chances are done to end the main process, and the figure ID stored in the RAM 33 is deleted to clear the game progress mode flag. As described above, in the game system 100, it is configured in which when the process is moved to the second game state, even though the bonus game transition condition is not held, the special lottery game using the figure ID can be played. Motivation is effected on a player to use a figure 90 to repeatedly play games.

The game system according to the embodiment also exerts the same effects and advantages as those of the slot machines 1A and 1B described above. Furthermore, the game server 20 stores and associates game data about the second special game such as the labyrinth combat image game and the special lottery game with the figure ID, and the game data corresponding to the figure ID set from the slot machine 1C is transmitted to the slot machine 1C for playing a game. Thus, the variations of the second special game can be increased. Furthermore, a configuration is possible in which the game server can play a combat game between the individual slot machines 1C based on the figure ID sent from multiple the slot machines 1C. Therefore, the expandability of the game descriptions is enhanced.

As described above, the game machine and the game system according to the invention have been described based on each of the embodiments. However, the invention will not be limited to the embodiments above. For example, for the game item, it is not limited to the figure, which may be a card, a cassette, etc. Furthermore, in the embodiments, the special lottery game and the labyrinth combat image game have been described as the second special game, but which is not limited thereto. For example, it may be an image game such as done by displaying tramp images, and an image game done by displaying piece images of chess. Moreover, the mode that game related information is stored in the game item is not limited to the IC chip that can read data in a non-contact manner, and it may be a contact data storage module. Besides, the data storage module such as memory may not be placed, and such a configuration may be formed in which an information display part having an information storage function is provided by attaching a seal where barcodes and two-dimensional codes are printed and by directly printing or marking them on a game item for storing game related information in the game item. In addition, the two-dimensional codes are also called two-dimensional barcodes. For example, there is QRcode (the trademark of DENSO WAVE INCORPORATED). The two-dimensional codes contain a large volume of information that data tens to hundreds times barcodes is coded. In this manner, when the information display part is provided, a barcode reader, etc., are disposed instead of the IC chip reader/writer described above.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A game machine capable of playing a variable display game using a plurality of symbols that are variably displayed, the game machine comprising:
a reading unit which reads identification information from a game item that stores identification information which distinguishes oneself from another;
a read determining unit which determines whether or not to have read the identification information by the reading unit;
a mode determining unit which determines which game progress mode it is, a first game progress mode or a second game progress mode based on whether or not to have read the identification information by the read determining unit, the first game progress mode can advance a game in a base game state that can play the variable display game and in a first special game state that can play a first special game different from the variable display game, and the second game progress mode can advance a game in the base game state and in a second special game state that can play a second special game using the identification information read by the reading unit; and
a game progress control unit which advances a game in the first or second game progress mode determined by the mode determining unit.

2. The game machine according to claim 1, comprising a display which displays the motif as a variable display image.

3. The game machine according to claim 1 or 2, wherein the second special game is conducted using a usage of the game item corresponding to the identification information.

4. A game system comprising:
a game machine which can play variable display game using a plurality of symbols that are variably displayed; and
a game server which is connected to the game machine:
the game machine includes:
a reading unit which reads identification information from a game item that stores identification information which distinguishes oneself from another;
a read determining unit which determines whether or not to have read the identification information by the reading unit;
a communication processing unit which sends the identification information read by the reading unit to the game server and receives a usage of the game item corresponding to the sent identification information from the game server;
a mode determining unit which determines which game progress mode it is, a first game progress mode or a second game progress mode based on whether or not to have read the identification information by the read determining unit, the first game progress mode can advance a game in a base game state that can play the variable display game and in a first special game state that can play a first special game different from the variable display game, and the second game progress mode can advance a game in a second special game state that can play a second special game using a usage received by the communication processing unit; and
a game progress control unit which advances a game in the first or second game progress mode determined by the mode determining unit, and
the game server includes:
a communication processing unit which receives identification information sent from the game machine and sends usage information indicating a usage of the game item corresponding to the received identification information to the game machine.
